(19) United States
(12) Patent Application Publication
(10) Pub. No.: US 2019/0371005 A1
(43) Pub. Date: Dec. 5, 2019

(54) RECORDING MEDIUM, COLOR LABEL, DETECTION DEVICE, IMAGE PROCESSING DEVICE, IMAGE PROCESSING METHOD AND IMAGE PROCESSING SYSTEM

(71) Applicant: Sumitomo Electric Industries, Ltd., Osaka-shi, Osaka (JP)

(72) Inventors: Michikazu UMEMURA, Osaka-shi, Osaka (JP); Yuri KISHITA, Osaka-shi, Osaka (JP)

(73) Assignee: Sumitomo Electric Industries, Ltd., Osaka-shi, Osaka (JP)

(21) Appl. No.: 16/461,883

(22) PCT Filed: Sep. 1, 2017
(86) PCT No.: PCT/JP2017/031584

§ 371 Date: May 17, 2019

(30) Foreign Application Priority Data
Dec. 7, 2016 (JP) 2016-237508

(51) Int. Cl. G06T 7/90; G06T 7/11; G06T 7/70

(52) U.S. Cl. CPC G06T 7/90; G06T 7/11; G06F 3/0482; G06T 2200/24; G06T 7/70

(57) ABSTRACT

An computer readable non-transitory recording medium records an image processing program causes a computer to function as: an image acquisition unit that acquires an image obtained by photographing a detection target area including an object; an occurrence frequency calculation unit that calculates for each color an occurrence frequency of the color in the image, based on the image acquired by the image acquisition unit; and a low frequency color determination unit that determines a low frequency color being a color low in occurrence frequency as compared with other colors based on the occurrence frequency for each color calculated by the occurrence frequency calculation unit.

### TECHNICAL FIELD

The present invention relates to an image processing program, a color label, a detection device, an image processing device, an image processing method and an image processing system.

The present application claims the benefit of Japanese Patent Application No. 2016-237508 filed on Dec. 7, 2016, the entire contents of which are herein incorporated by reference.

### BACKGROUND ART

A technique for detecting an object from an image photographed by a camera has conventionally been developed.

Patent Document 1, for example, discloses a safety device for a forklift for detecting a person around the forklift. Different profiles with a preset color are drawn on the forklift and the helmet of the person, and the forklift and the person are photographed by a fixed camera set in advance on the ceiling. The safety device extracts the profiles and color from the photographed image to thereby detect the forklift and the person, and issues a notification when the forklift and the person approach within a certain distance.

Meanwhile, Patent Document 2 discloses a human detection system for construction machine for detecting a human around the vehicle-type construction machine. In Patent Document 2, using an image photographed by a camera attached to a shovel serving as a vehicle type construction machine, a human positioned around the shovel is detected.

### PRIOR ART DOCUMENT

### Patent Document

[Patent Document 1] Japanese Patent Laid-Open Publication No. H9-169500

[Patent Document 2] WO2015/186570

### SUMMARY OF INVENTION

(1) An image processing program according to one embodiment of the present disclosure causes a computer to function as: an image acquisition unit that acquires an image obtained by photographing a detection target area including an object; an occurrence frequency calculation unit that calculates for each color an occurrence frequency of the color in the image, based on the image acquired by the image acquisition unit; and a low frequency color determination unit that determines a low frequency color being a color low in occurrence frequency as compared with other colors based on the occurrence frequency for each color calculated by the occurrence frequency calculation unit.

(10) A color label according to another embodiment of the present disclosure emits light with a low frequency color determined by executing on a computer the above-described image processing program.

(11) A detection device according to another embodiment of the present disclosure comprises: a threshold acquisition unit that acquires a threshold for identifying a low frequency color determined by executing on a computer the above-described image processing program; an image acquisition unit that acquires an image of a detection target area including an object; and a detection unit that detects that the low frequency color is included in the image acquired by the image acquisition unit based on the threshold acquired by the threshold acquisition unit.

(12) An image processing apparatus according to another embodiment of the present disclosure comprises: an image acquisition unit that acquires an image obtained by photographing a detection target area including an object; an occurrence frequency calculation unit that calculates for each color an occurrence frequency of the color in the image, based on the image acquired by the image acquisition unit; and a low frequency color determination unit that determines a low frequency color being a color low in occurrence frequency as compared with other colors based on the occurrence frequency for each color calculated by the occurrence frequency calculation unit.

(13) An image processing method according to another embodiment of the present disclosure comprises: acquiring an image obtained by photographing a detection target area including an object; calculating for each color an occurrence frequency of the color in the image based on the acquired image; and determining a low frequency color being a color low in occurrence frequency as compared with other colors based on the calculated occurrence frequency for each color.

(14) An image processing system according to another embodiment of the present disclosure comprises: the above-described image processing apparatus; the above-described color label; and the above-described detection device.

### BRIEF DESCRIPTION OF DRAWINGS

FIG. 1 illustrates the overall configuration of an image processing system according to Embodiment 1 of the present disclosure.

FIG. 2 illustrates an installation example of the image processing system 1.

FIG. 3 is a block diagram illustrating the functional configuration of an analysis device according to Embodiment 1 of the present disclosure.

FIG. 4 is a block diagram illustrating the functional configuration of a detection device according to Embodiment 1 of the present disclosure.

FIG. 5 is a block diagram illustrating the configuration of a color label 5 according to Embodiment 1 of the present disclosure.

FIG. 6 illustrates a helmet to be worn by a person as seen from the side.

FIG. 7 illustrates an object to be detected as seen from the side-upper direction.

FIG. 8 is a flowchart of one example of a processing procedure performed by the analysis device according to Embodiment 1 of the present disclosure.

FIG. 9 is a flowchart of a detailed processing procedure of low frequency color candidate determination processing (S8).

FIG. 10 illustrates one example of an R-G-B signal histogram.

FIG. 11 illustrates one example of an R signal histogram.

FIG. 12 illustrates one example of an R-G signal histogram.

FIG. 13 illustrates low frequency color determination processing.

FIG. 14 is a flowchart of another example of a processing procedure performed by the analysis device according to Embodiment 1 of the present disclosure.

FIG. 15 is a flowchart of one example of a processing procedure performed by the detection device according to Embodiment 1 of the present disclosure.

FIG. 16 illustrates an example of a threshold stored in a threshold determination unit.

FIG. 17 illustrates a flowchart of another example of the processing procedure performed by the detection device according to the embodiment of the present disclosure.

FIG. 18 is a block diagram illustrating the functional configuration of an analysis device according to Embodiment 2 of the present disclosure.

FIG. 19 is a block diagram illustrating the functional configuration of, a detection device according to Embodiment 2 of the present disclosure.

FIG. 20 illustrates an example of a threshold stored in a threshold storage unit.

FIG. 21 is a flowchart of one example of a processing procedure performed by the analysis device according to Embodiment 2 of the present disclosure.

FIG. 22 is a flowchart of one example of a processing procedure performed by the detection device according to Embodiment 2 of the present disclosure.

FIG. 23 is a flowchart of another example of the processing procedure performed by the detection device according to Embodiment 2 of the present disclosure.

FIG. 24 is a block diagram illustrating the functional configuration of an analysis device according to Embodiment 3 of the present disclosure.

FIG. 25 is a block diagram illustrating the functional configuration of a detection device according to Embodiment 3 of the present disclosure.

FIG. 26 illustrates an example of a threshold stored in a threshold storage unit.

FIG. 27 is a flowchart of one example of a processing procedure performed by the analysis device according to Embodiment 3 of the present disclosure.

FIG. 28 is a flowchart of one example of a processing procedure performed by the detection device according to Embodiment 3 of the present disclosure.

FIG. 29 is a flowchart of another example of the processing procedure performed by the detection device according to Embodiment 3 of the present disclosure.

FIG. 30 is a block diagram illustrating the functional configuration of an analysis device according to Embodiment 4 of the present disclosure.

FIG. 31 illustrates a helmet to be worn by the person when viewed from the side.

FIG. 32 illustrates a helmet to be worn by the person when viewed from above.

FIG. 33 illustrates an example of a threshold stored in a threshold storage unit.

FIG. 34 is a flowchart of one example of a processing procedure performed by the analysis device according to Embodiment 4 of the present disclosure.

FIG. 35 is a flowchart of a detailed processing procedure of the processing for determining candidates for sets of low frequency size and low frequency color (S8B).

FIG. 36 illustrates one example of an S-R-G-B signal histogram.

FIG. 37 illustrates one example of an S-R signal histogram.

FIG. 38 is a flowchart of one example of a processing procedure performed by the detection device according to Embodiment 4 of the present disclosure.

FIG. 39 is a flowchart of another example of the processing procedure performed by the detection device according to Embodiment 4 of the present disclosure.

### MODE FOR CARRYING OUT INVENTION

### Problems to be Solved by Disclosure

Patent Document 1, however, does not disclose how to determine the color of the profiles to be drawn on the forklift and the helmet of the person. This makes it unable to accurately detect the person in the case where an object, etc. with a color similar to that of the profiles exists within the camera photographed range.

Meanwhile, Patent Document 2 detects a helmet worn by a human in order to detect the human. This also makes it unable to accurately detect the helmet in the case where an object, etc. with a color similar to that of the helmet exists within the camera photographed range.

It is an object of the present invention to provide an image processing program capable of determining a color to be applied to an object in order to accurately detect the object by image processing, an image processing apparatus and an image processing method.

It is another object of the present invention to provide a color label capable of being accurately detected by the image processing.

It is a further object of the present invention to provide a detection device capable of accurately detecting the object and an image processing system.

### Effects of Disclosure

According to the disclosure, it is possible to determine a color to be applied to an object in order to accurately detect the object by image processing.

It is also possible to provide a color label capable of being accurately detected by the image processing.

It is further possible to accurately detect the object.

### Description of Embodiments of Present Application

The outline of embodiments of the present disclosure are first listed.

(1) The image processing program according to one embodiment of the present disclosure causes a computer to function as: an image acquisition unit that acquires an image obtained by photographing a detection target area including an object; an occurrence frequency calculation unit that calculates for each color an occurrence frequency of the color in the image, based on the image acquired by the image acquisition unit; and a low frequency color determination unit that determines a low frequency color being a color low in occurrence frequency as compared with other colors based on the occurrence frequency for each color calculated by the occurrence frequency calculation unit.

According to this configuration, a low frequency color being a color relatively low in occurrence frequency can be determined from the image obtained by photographing the detection target area including the object. Thus, it is possible to determine the color to be applied to the object in order to accurately detect the object by the image processing. In other words, by applying such a low frequency color to the object, the region with the low frequency color can accurately be detected from the image obtained by photographing the detection target area without being affected by the color of other regions. This makes it possible to accurately detect the object. For example, a low frequency color is determined from an image obtained by photographing the interior of a factory, and the color label developing the low frequency color is pasted on the helmet worn by the person. The color of the color label is assured to be low in occurrence frequency in the image. Thus, the color label pasted on the helmet can accurately be detected by the image processing, which enables accurate detection of the person.

(2) Preferably, the low frequency color determination unit determines the low frequency color in view of the occurrence frequency of each color included in a plurality of colors positioned close to each other in a predetermined color space.

According to this configuration, in the case where a color around the color being low in occurrence frequency in the color space is also low in occurrence frequency, the color being low in occurrence frequency can preferentially be determined as a low frequency color. Thus, even if the color of the object corresponding to the low frequency color slightly changes in the image due to the changes of environmental conditions such as solar radiation, weather, lighting or the like, the occurrence frequency of the changed color can also be made low. This enables accurate detection of the object from the image by the image processing without being affected by the changes of the environmental conditions.

(3) Preferably, the computer is caused to further function as: a region division unit that performs processing of dividing the image acquired by the image acquisition unit into regions based on a color of each pixel; and a region feature calculation unit that calculates for each region obtained through division by the region division unit a size and a representative color of the region. The occurrence frequency calculation unit calculates for each set of size and representative color an occurrence frequency in the image of a region including the set based on the size and the representative color of the region calculated by the region feature calculation unit, and the low frequency color determination unit determines a set of size and representative color being low in occurrence frequency than other sets based on the occurrence frequency of the region for each set calculated by the occurrence frequency calculation unit.

According to this configuration, by the region division processing, an image is divided into regions each formed of pixels with a similar color. Furthermore, based on the occurrence frequency of a set of size and representative color for each region, a set of size and representative color being relatively low in occurrence frequency can be determined. This makes it possible to determine the color to be applied to the object and the size of the color in order to accurately detect the object by the image processing. For example, by attaching a label with the determined size and representative color to an object and detecting the label with the size and the representative color from the image by the image processing, the object can accurately be detected.

(4) Preferably, the low frequency color determination unit determines a plurality of low frequency colors by preferentially selecting a set of low frequency colors with an increased distance between the colors based on the occurrence frequency.

The discernibleness of the color increases as the distance between the colors increases. According to this configuration, the multiple low frequency colors are determined in such a manner that the distance between the colors increases. For example, in the case where two low frequency colors are selected out of three low frequency colors, a pair of low frequency colors with the longest distance therebetween is selected out of the three pairs of low frequency colors. If a pair of low frequency colors with a short distance therebetween is selected, the low frequency colors may be identified as the same color by the image processing depending on the environmental condition such as solar radiation, weather, lighting or the like, and cannot be discerned. However, by selecting a pair of low frequency colors with a long distance therebetween, the low frequency colors can be discerned irrespective of the environmental condition.

(5) Preferably, the computer is caused to further function as: a display control unit that displays the plurality of low frequency colors determined by the low frequency color determination unit on a screen; and a selection color acquisition unit that acquires a selection color being a color selected by a user out of the plurality of low frequency colors displayed on the screen. The display control unit further displays the plurality of low frequency colors on the screen depending on a distance from the selection color acquired by the selection color acquisition unit.

According to this configuration, in the case where multiple low frequency colors are determined by the low frequency color determination unit, depending on the distance from the selection color selected by the user out of the multiple low frequency colors, the rest of the low frequency colors are displayed on the screen. For example, the rest of the low frequency colors are displayed in such an order that the color with a longer distance from the selection color is ranked higher, which allows the user to readily select the low frequency color with high discernibleness.

(6) Preferably, the computer is caused to further function as: a time acquisition unit that acquires an acquisition time of the image acquired by the image acquisition unit. The occurrence frequency calculation unit calculates an occurrence frequency for each color depending on a time period including the acquisition time acquired by the time acquisition unit, and the low frequency color determination unit determines a low frequency color depending on the time period based on the occurrence frequency calculated by the occurrence frequency calculation unit.

According to this configuration, the low frequency color can be determined for each time period. Thus, even in the case where an object is detected from an image photographed in the outdoors, etc. where lighting environment changes depending on the time period, for example, the color of the color label to be applied to the object can be changed depending on the time period. This makes it possible to detect the object in any time period with high accuracy.

(7) Preferably, the computer is caused to further function as: a position acquisition unit that acquires an acquisition position of the image acquired by the image acquisition unit. The occurrence frequency calculation unit calculates an occurrence frequency for each color depending on an area to which the acquisition position acquired by the position acquisition unit belongs, and the low frequency color determination unit determines a low frequency color depending on the area based on the occurrence frequency calculated by the occurrence frequency calculation unit.

According to this configuration, the low frequency color can be determined for each area. Thus, even in the case where an object is detected from an image photographed by a camera mounted on the vehicle, or even in the case where an object is detected from images photographed by cameras placed in multiple areas, for example, the color of the color label to be applied to the object is changed depending on the position of the camera, whereby the object can be detected with high accuracy.

(8) Preferably, the computer is caused to further function as: a designation color acquisition unit that acquires a designation color; and an output unit that outputs information on an occurrence frequency of the designation color acquired by the designation color acquisition unit based on the occurrence frequency for each color calculated by the occurrence frequency calculation unit.

According to this configuration, the user can learn the occurrence frequency or the levels of the occurrence frequency, etc. of the designation color in the image. For example, the user designates in the image the label developing the low frequency color determined by the low frequency color determination unit. This allows the user to learn whether or not the color of the label is actually low in occurrence frequency, or to confirm whether or not the label emits light with an appropriate color.

(9) Preferably, the computer is caused to further function as a threshold determination unit that determines a threshold for identifying the low frequency color based on the low frequency color determined by the low frequency color determination unit.

According to this configuration, it is possible to determine a threshold for identifying the low frequency color by another detection device or the like.

(10) The color label according to another embodiment of the present disclosure emits light of a low frequency color determined by executing on a computer the above-described image processing program.

According to this configuration, the color label develops a color being low in occurrence frequency in the image. In other words, the pixel with a color the same as or similar to that of the color label is less likely to be present in the image. This enables accurate detection of the color label in distinction from other regions by the image processing. Thus, it is possible to provide the color label that is accurately detected by the image processing.

(11) The detection device according to another embodiment of the present disclosure comprises: a threshold acquisition unit that acquires a threshold for identifying a low frequency color determined by executing on a computer the above-described image processing program; an image acquisition unit that acquires an image of a detection target area including an object; and a detection unit that detects that the low frequency color is included in the image acquired by the image acquisition unit based on the threshold acquired by the threshold acquisition unit.

According to this configuration, the detection device can detect that the low frequency color is included in the image. The low frequency color is a color rarely included in the background, etc. in the image. Hence, by applying the low frequency color to the object, the object can accurately be detected without being affected by the color of the background, etc.

(12) The image processing apparatus according to another embodiment of the present disclosure comprises: an image acquisition unit that acquires an image obtained by photographing a detection target area including an object; an occurrence frequency calculation unit that calculates for each color an occurrence frequency of the color in the image, based on the image acquired by the image acquisition unit; and a low frequency color determination unit that determines a low frequency color being a color low in occurrence frequency as compared with other colors based on the occurrence frequency for each color calculated by the occurrence frequency calculation unit.

This configuration includes as a component the processing unit operated by the computer according to the above-described image processing program. This makes it possible to produce similar operation and effect to those of the above-described image processing program.

(13) The image processing method according to another embodiment of the present disclosure comprises: acquiring an image obtained by photographing a detection target area including an object; calculating for each color an occurrence frequency of the color in the image based on the acquired image; and determining a low frequency color being a color low in occurrence frequency as compared with other colors based on the calculated occurrence frequency for each color.

The configuration includes the steps corresponding to the processing unit operated by the computer according to the above-described image processing program. This makes it possible to produce similar operation and effect to those of the above-described image processing program.

(14) The image processing system according to another embodiment of the present disclosure comprises: the above-described image processing apparatus; the above-described color label; and the above-described detection device.

The configuration comprises the above-described image processing apparatus, the above-described color label and the above-described detection device. According to this image processing apparatus, it is possible determine a low frequency color that is a color being relatively low in occurrence frequency from the image obtained by photographing the detection target area including the object. Furthermore, the color label develops the low frequency color. That is, the color label develops a color being low in occurrence frequency in the image, and the pixel with a color the same as or similar to that of the color label is less likely to be present in the image. Hence, the detection device accurately detect the color label from the image obtained by photographing the detection target area without being affected by the colors of other regions. By applying the color label to the object, the detection device can accurately detect the object. For example, a low frequency color is determined from an image obtained by photographing the interior of a factory, and a color label developing the low frequency color is applied to a helmet worn by a person. The color of the color label is assured to be low in occurrence frequency in the image. Thus, the helmet can accurately be detected by the image processing, which enables accurate detection of the person.

Note that it is possible to achieve a semiconductor integrated circuit achieving a part or all of the image processing apparatus or the detection device according to the present disclosure.

### Detailed Description of Embodiments of the Invention

The embodiments of the present disclosure will be described below in detail with reference to the drawings. It is to be understood that the embodiments described below are to be taken as preferred concrete examples of the present disclosure. The numerals, shapes, materials, components, arrangement of the components, connected states, steps, the order of the steps, etc. that are indicated in the embodiments below are mere examples and are not intended to limit the present disclosure. The present disclosure is defined by the appended claims. Thus, some components in the components of the following embodiments that are not described in the independent claims indicating the most general concept of the present disclosure are described as ones that constitute more preferable modes although they are not necessarily required to solve the problems of the present disclosure.

### Embodiment 1

[Overall Configuration of Image Processing System]

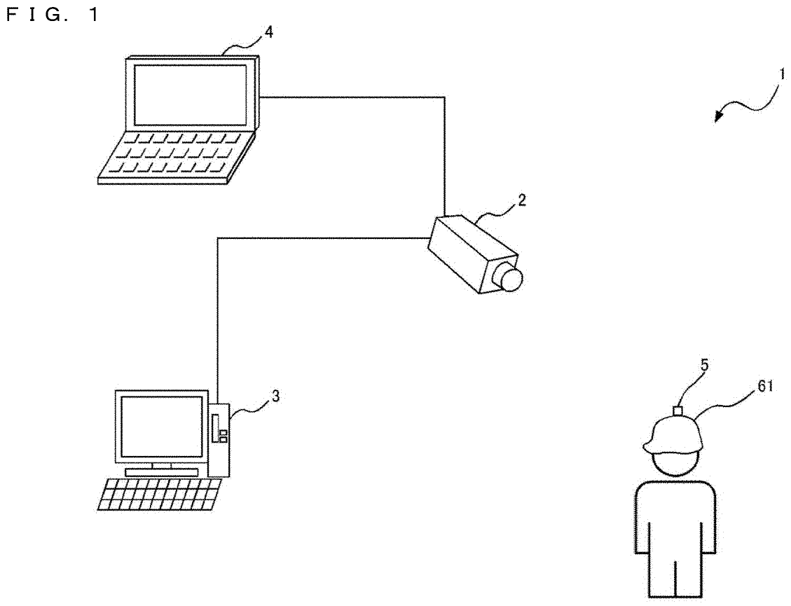

FIG. 1 illustrates the overall configuration of an image processing system according to Embodiment 1 of the present disclosure. Described in Embodiment 1 is an example in which a person 61 is detected as an object within a detection target area. Note that the object may be another mobile unit such as a vehicle, etc. and a pillar, a fixture, etc. installed in advance within the detection target area, not limited to the person 61.

The image processing system 1 is a system for detecting an object within a predetermined detection target area, and includes a camera 2, an analysis device 3, a detection device 4 and a color label 5.

The camera 2 photographs a preset detection target area and outputs a photographed image as a video signal.

The analysis device 3 constitutes an image processing apparatus, and acquires an image (video image) of the detection target area from the camera 2 and determines a low frequency color being a color with a relatively low occurrence frequency in the acquired image. The analysis device 3 and the camera 2 may be connected by a wire or may be connected by a mobile phone network in compliance with a communication standard such as 4G or the like, or a wireless local area network (LAN) such as Wi-Fi (registered trademark) or the like. Alternatively, the camera 2 writes the photographed image in a recording medium while the analysis device 3 reads out the image of the detection target area from the recording medium, or the like.

It is noted that the low frequency color determination processing performed by the analysis device 3 is executed as preprocessing performed prior to detection processing of the person 61 performed by the detection device 4, which will be described later.

The color label 5 develops the low frequency color determined by the analysis device 3. The color label 5 is attached to the person 61 corresponding to an object. The color label 5 is pasted on the helmet, for example, worn by the person 61.

The detection device 4 acquires an image of the detection target area from the camera 2 and detects the person 61 corresponding to the object by detecting the color label 5 developing the low frequency color in the acquired image. The detection device 4 and the camera 2 may be connected by a wire or may be connected by a mobile phone network in compliance with a communication standard such as 4G or the like, or a wireless LAN such as Wi-Fi (registered trademark) or the like.

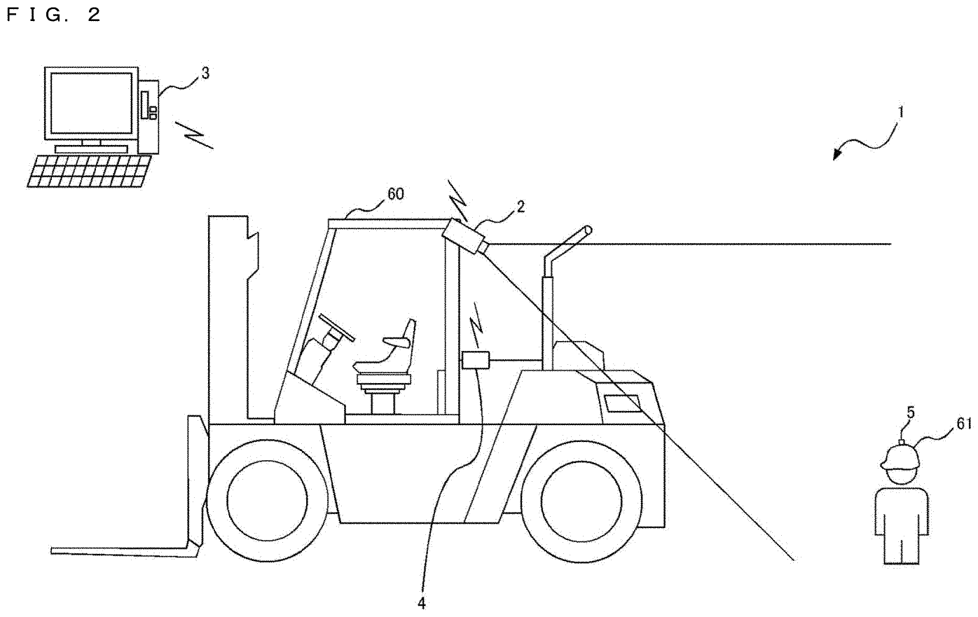

FIG. 2 illustrates an installation example of the image processing system 1.

The image processing system 1, for example, is a system for monitoring the surroundings of a forklift 60, and the camera 2 is attached at a position capable of monitoring the rear side of the forklift 60 (at the rear end position of the overhead guard of the forklift 60, for example). Thus, the rear side of the forklift 60 is regarded as a target area for detecting the person 61.

The camera 2 and the analysis device 3 are, for example, connected by a wireless LAN while the camera 2 and the detection device 4 are connected by a wire.

The detection device 4 detects the person 61 by detecting the color label 5 from the image photographed by the camera 2.

[Configuration of Analysis Device 3]

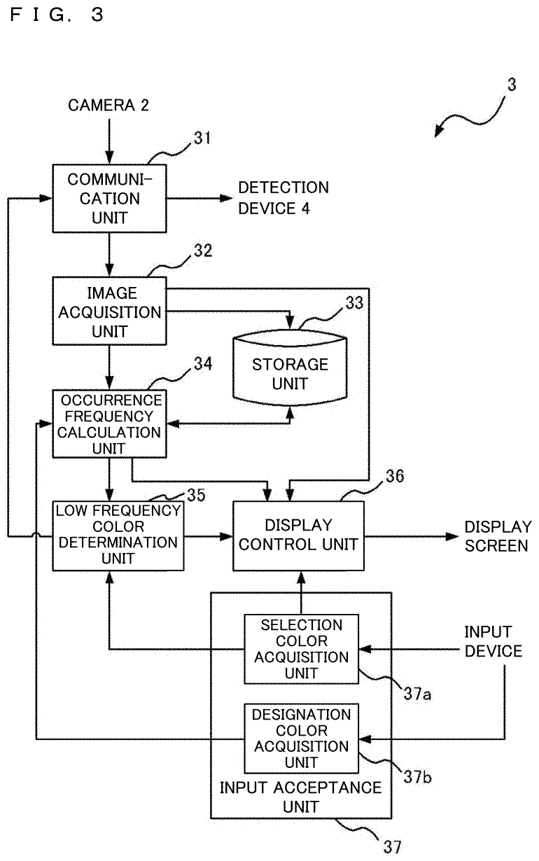

FIG. 3 is a block diagram illustrating the functional configuration of the analysis device 3 according to Embodiment 1 of the present disclosure.

The analysis device 3 includes a communication unit 31, an image acquisition unit 32, a storage unit 33, an occurrence frequency calculation unit 34, a low frequency color determination unit 35, a display control unit 36 and an input acceptance unit 37.

The communication unit 31 is a processing unit for communicating with the camera 2 or the detection device 4, and is configured to include a communication interface to establish wired connection or wireless connection, for example, with the camera 2 or the detection device 4.

The image acquisition unit 32 acquires from the camera 2 an image of the detection target area photographed by the camera 2 via the communication unit 31. The image acquisition unit 32 accumulates the acquired image into the storage unit 33.

The storage unit 33 is a storage device for accumulating images acquired by the image acquisition unit 32 and is formed of, for example, a random access memory (RAM), a flash memory, a hard disk drive (HDD) or the like.

The occurrence frequency calculation unit 34 calculates an occurrence frequency in an image for each color based on the image acquired by the image acquisition unit 32. In the case of representing a color by luminance values of R (red), G (green) and B (blue) in a RGB color space, the occurrence frequency calculation unit 34 calculates an occurrence frequency for each set of luminance values (R, G,

Note that color may be represented by hue (H), saturations (S) and brightness (V).

Note that if calculating an occurrence frequency based on multiple sheets of images acquired by the image acquisition unit 32, the occurrence frequency calculation unit 34 reads out the multiple sheets of images from the storage unit 33.

The low frequency color determination unit 35 determines a low frequency color being a color low in occurrence frequency in comparison with other colors based on the occurrence frequency for each color calculated by the occurrence frequency calculation unit 34. The low frequency color determination unit 35, for example, may determine a color for which the ratio of the occurrence frequency thereof to the total occurrence frequency obtained by summing the occurrence frequencies of all the colors is equal to or lower than a predetermined threshold, as a low frequency color. Alternatively, the low frequency color determination unit 35 may determine as low frequency colors a predetermined number of colors decided in advance in an ascending order of the occurrence frequency.

The display control unit 36 is formed of an output unit, and controls the display of the low frequency color determined by the low frequency color determination unit 35 on the display screen of the analysis device 3 or on the display screen of another device such as a terminal device or the like connected to the analysis device 3 via a network, or the like.

The input acceptance unit 37 is a processing unit for accepting an input by the user via an input device such as a keyboard, a mouse, a touch panel or the like, and includes a selection color acquisition unit 37a and a designation color acquisition unit 37b.

The selection color acquisition unit 37a accepts a selection input from the user out of the multiple low frequency colors displayed on the display screen by the display control unit 36 and acquires the selection color regarding as a low frequency color selected by the user.

The designation color acquisition unit 37b acquires a designation color corresponding to the color designated by the user operating the input device. For example, if the user designates a position on the image displayed on the display screen, the designation color acquisition unit 37b acquires the color corresponding to the position as a designation color. Alternatively, if the user designates a position of a color pallet displayed on the display screen, the designation color acquisition unit 37b acquires the color corresponding to the position as a designation color.

In the case where the designation color acquisition unit 37b acquires a designation color, the occurrence frequency calculation unit 34 calculates the occurrence frequency corresponding to the designation color while the display control unit 36 displays the calculated occurrence frequency on the display screen.

[Configuration of Detection Device 4]

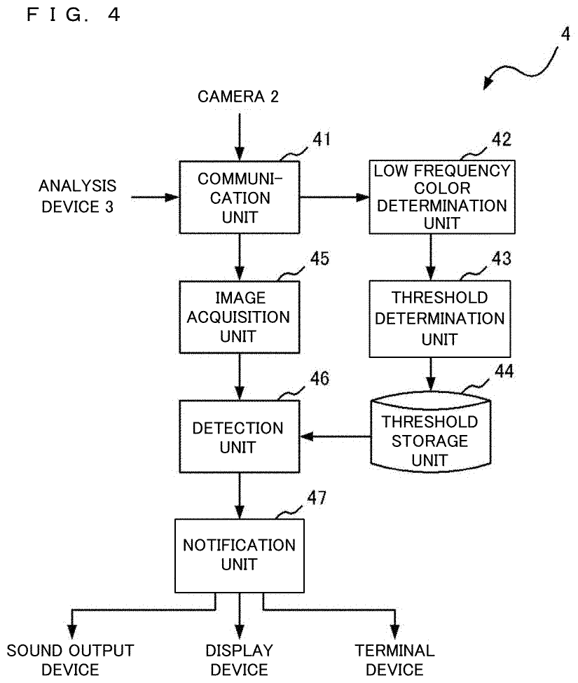

FIG. 4 is a block diagram illustrating the functional configuration of the detection device 4 according to Embodiment 1 of the present disclosure.

The detection device 4 includes a communication unit 41, a low frequency color acquisition unit 42, a threshold determination unit 43, a threshold storage unit 44, an image acquisition unit 45, a detection unit 46 and a notification unit 47.

The communication unit 41 is a processing unit for communicating with the camera 2 or the analysis device 3 and is configured to include a communication interface to establish wired connection or wireless connection with the camera 2 or the analysis device 3.

The low frequency color acquisition unit 42 acquires from the analysis device 3 the low frequency color determined by the analysis device 3 via the communication unit 41. In the case of representing a color by luminance values of R, G and B in a RGB color space, for example, the low frequency color acquisition unit 42 acquires a set of luminance values (R, G, B) corresponding to the low frequency color.

The threshold determination unit 43 functions as a threshold acquisition unit and determines a threshold for detecting the color label 5 developing the low frequency color determined by the analysis device 3 based on the low frequency color acquired by the low frequency color acquisition unit 42. In the case where a set of luminance values of the low frequency color is (R1, G1, B1), for example, the threshold determination unit 43 determines that the lower threshold limit of the threshold is (R1−10, G1−10, B1−10), and that the upper threshold limit of the threshold is (R1+10, G1+10, B1+10). The threshold determination unit 43 writes the determined threshold into the threshold storage unit 44. Note that if the low frequency color acquisition unit 42 acquires multiple low frequency colors, the threshold determination unit 43 determines a threshold for each of the low frequency colors and writes it into the threshold storage unit 44.

The threshold storage unit 44 is a storage device for storing a threshold determined by the threshold determination unit 43, and is formed of, for example, a RAM, a flash memory, an HDD, or the like.

The image acquisition unit 45 acquires from the camera 2 an image of the detection target area photographed by the camera 2 via the communication unit 41.

The detection unit 46 detects that the low frequency color acquired by the low frequency color acquisition unit 42 is included in the image acquired by the image acquisition unit 45, that is, the color label 5 is included. Namely, the detection unit 46 reads out the threshold from the threshold storage unit 44 and determines whether or not a low frequency color is included in the read image based on the threshold read out and the color of each pixel of the acquired image. For example, if a set of luminance values (R, G, B) for each pixel of the acquired image falls within the range between the upper threshold limit and the lower threshold limit that had been read out, the detection unit 46 detects that the low frequency color is included in the image. This allows the detection unit 46 to detect the color label 5.

If the detection unit 46 detects the low frequency color, that is, the color label 5, the notification unit 47 transmits a sound signal to the sound output device, transmits message information to a display device, or transmits a detection result to a terminal device, for example. This allows the sound output device to output a notification sound and the display device to display message information, for example. In the case where the sound output device and the display device are installed in the driver seat of the forklift 60, for example, the notification unit 47 can notify the driver of the forklift 60 that the person 6 is behind the forklift 60 with sound or an image via the sound output device and the display device. Alternatively, if the driver possesses a terminal device such as a smartphone or the like, the notification unit 47 can notify the driver that the person 6 is behind the forklift 60 with sound, an image or vibrations or the like.

Note that in the above-described configuration of the detection device 4, the configuration of the threshold determination unit 43 may be provided in the analysis device 3. In such a case, based on the low frequency color determined by the low frequency color determination unit 35 of the analysis device 3, the threshold determination unit 43 provided in the analysis device 3 determines a threshold for detecting the color label 5 developing this low frequency color. The threshold determination unit 43 transmits the determined threshold to the detection device 4 via the communication unit 31. The detection device 4 is provided with the threshold acquisition unit instead of the low frequency color acquisition unit 42 and the threshold determination unit 43, and the threshold acquisition unit receives from the analysis device 3 the threshold determined by the analysis device 3 via the communication unit 41 and stores it in the threshold storage unit 44.

[Configuration of Color Label 5]

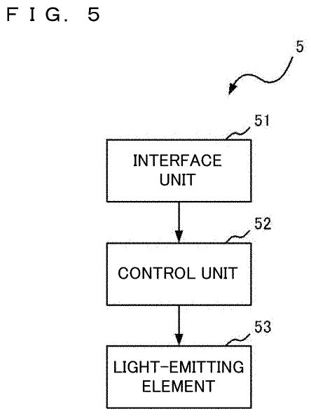

FIG. 5 is a block diagram illustrating the configuration of the color label 5 according to Embodiment 1 of the present disclosure.

The color label 5 is provided with an interface unit 51, a control unit 52 and a light emitting element 53.

The interface unit 51 is an interface for accepting a color to be set to the light emitting element 53. The interface unit 51, for example, may be an operation unit such as a switch or the like for allowing the user to set a set of luminance values (R, G, B) or may be a communication interface connected to an external apparatus for accepting a set of luminance values (R, G, B) from the external apparatus.

The control unit 52 controls the luminance color of the light-emitting element 53 such that the light-emitting element 53 emits light in the color accepted by the interface unit 51. The control unit 52 may be formed of a general purpose processor or the like, or may be formed of an integrated circuit such as an application specific integrated circuit (ASIC), a field-programmable gate array (FPGA) or the like, or an electric circuit.

The light-emitting element 53 is a light-emitting element that emits light in a color set by the control unit 52 and is formed of, for example, a light-emitting element such as a light-emitting diode (LED), an organic electroluminescence (EL) or the like.

Note that the color label 5 may be formed of a cloth, a tape, a paint or the like and may develop a specific color, not limited to the configuration illustrated in FIG. 5. In this case, it is more preferable that the color label 5 is formed of a fluorescent tape or is painted with a fluorescent paint. This makes it easy to perceive the color label 5 even in conditions of a low luminance such as in nighttime or cloudy conditions, for example. This also makes it possible to perceive the label without using a specific camera such as an infrared camera or the like.

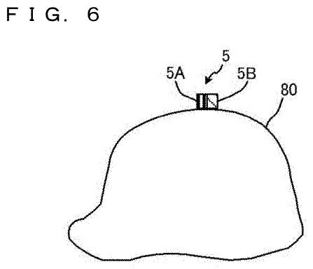

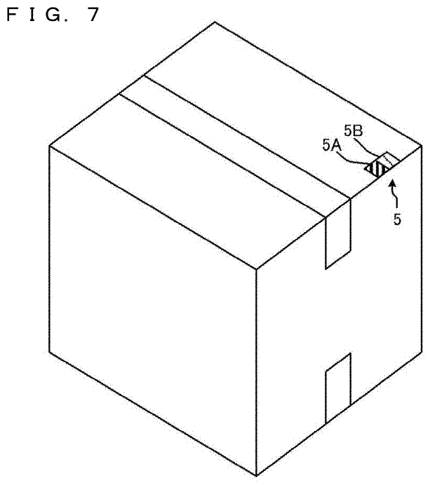

With reference to FIG. 6 and FIG. 7, an attachment example of the color label 5 will be described.

FIG. 6 illustrates a helmet to be worn by the person 61 as seen from the side. As illustrated in FIG. 6, the color label 5 is pasted around the top center of a helmet 80 (around the parietal region of the person 61). The color label 5 is composed of a first color label 5A and a second color label 5B that are arranged adjacent to each other. Note that the arrangement positions of the first color label 5A and the second color label 5B are not limited to the adjacent positions. A predetermined spacing between the first color label 5A and the second color label 5B may be provided. As such, positioning of the color label 5 around the parietal region of the person 61 makes the color label 5 visible from all direction. In the case where the color label 5 is configured to include the light-emitting element 53, visibility from a distant position is increased.

FIG. 7 illustrates an object to be detected as seen from the side upper direction. As illustrated in FIG. 7, for example, the color label 5 is pasted at a corner portion of a box, which is one example of an object. The color label 5 is composed of a first color label 5A and a second color label 5B that are arranged adjacent to each other similarly to that illustrated in FIG. 6. Note that the arrangement positions of the first color label 5A and the second color label 5B are not limited to the adjacent positions. A predetermined spacing between the first color label 5A and the second color label 5B may be provided. As such, attachment of the color label 5 at the corner portion of the box makes the color label 5 visible from all directions. Note that the attachment position of the color label 5 is not limited to a single corner. Attachment of the color labels 5 at multiple corners may enhance the visibility thereof. In the case where the color label 5 is configured to include the light-emitting element 53, visibility from a distant position is also increased.

[Processing Procedure by Analysis Device 3]

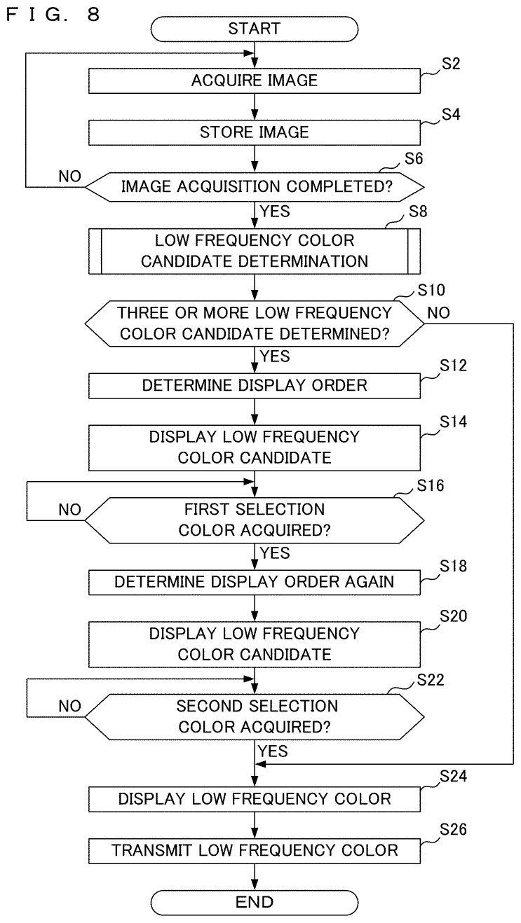

FIG. 8 is a flowchart of one example of a processing procedure performed by the analysis device 3 according to Embodiment 1 of the present disclosure.

The image acquisition unit 32 acquires from the camera 2 an image of the detection target area photographed by the camera 2 via the communication unit 31 (S2).

The image acquisition unit 32 writes the acquired image into the storage unit 33 to thereby store it in the storage unit 33 (S4).

The image acquisition unit 32 judges whether or not the image acquisition is completed (S6). If the image acquisition is not completed (NO at S6), the processing at steps S2 and S4 is repeatedly executed until the image acquisition is completed.

In the case where the camera 2 is mounted to the forklift 60 as illustrated in FIG. 2, for example, if the forklift 60 drives within a drivable range (within a factory, for example) thoroughly and acquires images in all the positions, it is judged that the image acquisition is completed.

The driver of the forklift 60 may judge the completion of the image acquisition and notify the analysis device 3 of the completion of the image acquisition. In the case where the camera 2 is fixed outdoors, the camera 2 may photograph an image at a predetermined cycle, and the image acquisition unit 32 may judge that the image acquisition is completed at a point in time when images of twenty-four hours are acquired.

If it is judged that the image acquisition is completed (YES at S6), the occurrence frequency calculation unit 34 and the low frequency color determination unit 35 determine a candidate for a low frequency color based on the images stored in the storage unit 33 (S8). Since the color label 5 includes two color labels of the first color label 5A and the second color label 5B, two or more candidates for the low frequency color are here assumed to be determined.

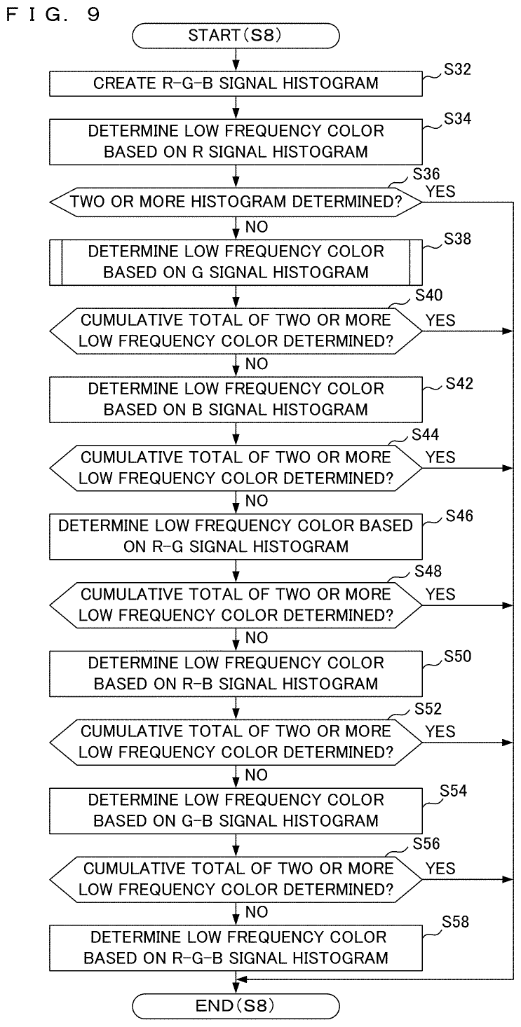

FIG. 9 is a flowchart of a detailed processing procedure of low frequency color candidate determination processing (S8).

Referring to FIG. 9, the occurrence frequency calculation unit 34 creates an R-G-B signal histogram from the images stored in the storage unit 33 (S32). The occurrence frequency calculation unit 34 stores the created R-G-B signal histogram in the storage unit 33.

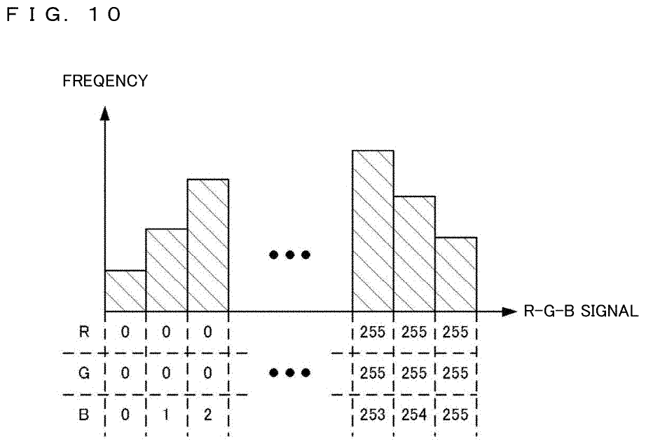

FIG. 10 illustrates one example of the R-G-B signal histogram, where the horizontal axis thereof indicates each of the luminance values (R, G, B) whereas the vertical axis thereof indicates the frequency of each of the sets of the luminance values. The luminance value R (R signal), the luminance value G (G signal) and the luminance value B (B signal) are each an integer value in the range of 0 to 255. In other words, the occurrence frequency calculation unit 34 tabulates the luminance values for the respective pixels in the image to thereby create the R-G-B signal histogram.

Subsequently, the occurrence frequency calculation unit 34 creates an R signal histogram from the R-G-B signal histogram whereas the low frequency color determination unit 35 determines a low frequency color based on the R signal histogram (S34).

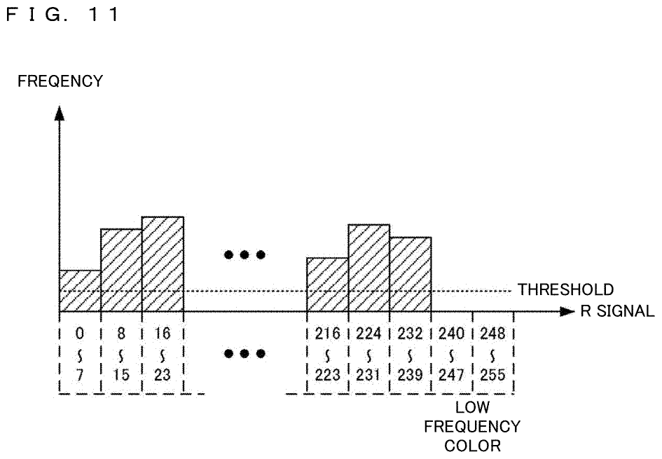

Describing in detail, FIG. 11 illustrates one example of the R signal histogram, where the horizontal axis thereof indicates R signals while the vertical axis thereof indicates the frequency of each of the R signals. Note that the R signals are quantized for every 8 steps (8 luminance values), for example. For example, one frequency is set to the R signal in the 0-7 class. Note that the number of steps for quantization may take any number, not limited to eight.

The low frequency color determination unit 35 determines the class of the R signal the frequency of which is equal to or less than a predetermined threshold based on the R signal histogram. The predetermined threshold may be zero, for example, or may be a value being one hundredth of the total frequencies of all the classes. It is noted that the threshold is one example and may take any value. For example, it is assumed that the R signals in the class 240-247 and the class 248-255 are determined according to the threshold processing by the low frequency color determination unit 35.

Subsequently, the low frequency color determination unit 35 determines one low frequency color for each class the frequency of which is equal to or less than the threshold. In the case where the classes are continuous to each other, one low frequency color is determined regarding the continuous classes as a single class. Since the R signals are continuous from the class 240-247 to the class 248-255, the low frequency color determination unit 35 determines one low frequency color from these two classes. For example, the low frequency color determination unit 35 determines a median value (R signal with 248 here) between the two classes as the value for the R signal of the low frequency color. Here, the low frequency color is determined from the R signal histogram without taking the G signal and the B signal into consideration. Hence, the values for the G signal and the B signal of the low frequency color may take any values. For example, the values for the G signal and the B signal may be determined at random or may be determined as median values or preset values of the values the respective signals may take.

The low frequency color determination unit 35 judges whether or not two or more low frequency colors are determined (S36). If two or more low frequency colors are determined (YES at S36), the low frequency color candidate determination processing (S8) is ended.

If two or more low frequency colors are not determined (NO at S36), the occurrence frequency calculation unit 34 creates a G signal histogram from the R-G-B signal histogram whereas the low frequency color determination unit 35 determines a low frequency color based on the G signal histogram (S38). The processing at step S38 is the same as the processing at step S34 except that the G signal is used in place of the R signal. The detailed description thereof is thus not repeated.

The low frequency color determination unit 35 judges whether or not a cumulative total of two or more low frequency colors is determined by the processing up to step S38 (S40). If the cumulative total of two or more low frequency colors are determined (YES at step S40), the low frequency color candidate determination processing (S8) is ended.

If the cumulative total of two or more low frequency colors are not determined (NO at step S40), the occurrence frequency calculation unit 34 creates a B signal histogram from the R-G-B signal histogram whereas the low frequency color determination unit 35 determines a low frequency color based on the B signal histogram (S42). The processing at step S42 is the same as the processing at step S34 except that the B signal is used in place of the R signal. The detailed description thereof is thus not repeated.

The low frequency color determination unit 35 judges whether or not the cumulative total of two or more low frequency colors are determined by the processing up to step S42 (S44). If the cumulative total of two or more low frequency colors are determined (YES at step S44), the low frequency color candidate determination processing (S8) is ended.

If the cumulative total of two or more low frequency colors are not determined (NO at step S44), the occurrence frequency calculation unit 34 creates a R-G signal histogram from the R-G-B signal histogram whereas the low frequency color determination unit 35 determines a low frequency color based on the R-G signal histogram (S46).

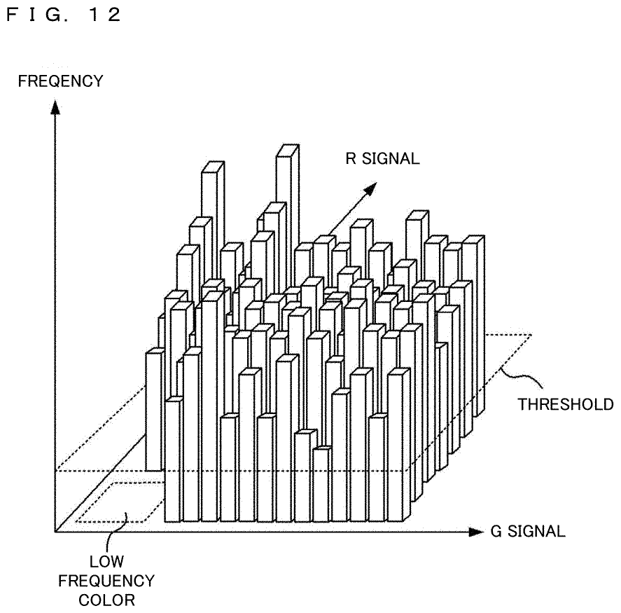

Describing in detail, FIG. 12 illustrates one example of the R-G signal histogram, where the first axis indicates R signals, the second axis perpendicular to the first axis indicates G signals, the third axis perpendicular to both of the first axis and the second axis indicates the frequency of each of the sets of R signal and G signal. It is noted that the R signals and the G signals are quantized for every 8 steps (8 luminance values), for example. For example, one frequency is set to the class (R, G)=(0-7, 0-7). Note that the number of steps for quantization may take any number, not limited to eight.

The low frequency color determination unit 35 determines a set of R signal and G signal (class) the frequency of which is equal to or less than a predetermined threshold from the R-G signal histogram. The predetermined threshold may be zero or may be a value of one tenth of the total frequencies of all the classes, for example. Note that the threshold is one example and may take any value.

The low frequency color determination unit 35 determines one low frequency color for each class the frequency of which is equal to or less than the threshold. In the case where the classes are continuous on a RG plane (plane defined by the first axis and the second axis), one low frequency color is determined regarding the continuous classes as one class. For example, the low frequency color determination unit 35 determines the median values for the R signal and for the G signal between these classes as values for the R signal and for the G signal of the low frequency color. Here, the low frequency color is determined from the R-G signal histogram without taking the B signal into consideration. The value for the B signal of the low frequency color may take any value. For example, the value for the B signal may be determined at random or may be determined as a median value or a preset value of the value the B signal may take.

The low frequency color determination unit 35 judges whether or not a cumulative total of two or more low frequency colors are determined by the processing up to step S46 (S48). If the cumulative total of two or more low frequency colors are determined (YES at S48), the low frequency color candidate determination processing (S8) is ended.

If the cumulative total of two or more low frequency colors are not determined (NO at S48), the occurrence frequency calculation unit 34 creates an R-B signal histogram from the R-G-B signal histogram whereas the low frequency color determination unit 35 determines a low frequency color based on the R-B signal histogram (S50). The processing at step S50 is the same as the processing at step S46 except that the B signal is used in place of the G signal. The detailed description thereof is thus not repeated.

The low frequency color determination unit 35 judges whether or not a cumulative total of two or more low frequency colors may be determined by the processing up to step S50 (S52). If the cumulative total of two or more low frequency colors are determined (YES at step S52), the low frequency color candidate determination processing (S8) is ended.

If the cumulative total of two or more low frequency colors are not determined (NO at step S52), the occurrence frequency calculation unit 34 creates a G-B signal histogram from the R-G-B signal histogram whereas the low frequency color determination unit 35 determines a low frequency color based on the G-B signal histogram (S54). The processing at step S54 is the same as the processing at step S46 except that the B signal is used in place of the R signal. The detailed description thereof is thus not repeated.

The low frequency color determination unit 35 judges whether or not the cumulative total of two or more low frequency colors are determined by the processing up to step S54 (S56). If the cumulative total of two or more low frequency colors are determined (YES at step S56), the low frequency color candidate determination processing (S8) is ended.

If the cumulative total of two or more low frequency colors are not determined (NO at step S56), the occurrence frequency calculation unit 34 quantizes signals for the respective colors every 8 steps (8 luminance values), for example, from the R-G-B signal histogram created at step S32 to thereby create a quantized R-G-B signal histogram. Note that the number of steps for quantization may take any number, not limited to eight. In the quantized R-G-B signal histogram, the first axis indicates R signals, the second axis perpendicular to the first axis indicates G signals, the third axis perpendicular to the first axis and the second axis indicates B signals, and the fourth axis perpendicular to the first axis, the second axis and the third axis indicates the frequency of each of the sets of R signals, G signals and B signals. The low frequency color determination unit 35 determines a low frequency color based on the quantized R-G-B signal histogram (S58).

Describing in detail, in the quantized R-G-B signal histogram, one frequency is set to the class (R, G, B)=(0-7, 0-7, 0-7), for example. The low frequency color determination unit 35 determines a set (class) of R signal, G signal and B signal the frequency of which is equal to or less than a predetermined threshold from the R-G-B signal histogram. The predetermined threshold may be zero, or may be a value of one twentieth of the total frequencies of all the classes, for example.

The low frequency color determination unit 35 determines one low frequency color for each class the frequency of which is equal to or less than the threshold. In the case where the classes are continuous on a RGB space (space defined by the first axis, the second axis and the third axis), one low frequency color is determined regarding the continuous classes as one class. For example, the low frequency color determination unit 35 determines the median values for the R signal, the G signal and the B signal between these classes as values for the R signal, the G signal and the B signal of the low frequency color.

By the processing from steps S32 to S58 described above, the candidates for the low frequency color are determined. It is noted that in the case where the color label 5 may be formed of three or more colors, if three or more candidates are also required to be determined, this is achieved by similar processing.

Referring again to FIG. 8, the low frequency color determination unit 35 judges whether or not three or more candidates for the low frequency color are determined (S10) according to the low frequency color candidate determination processing (S8) described above. If three or more candidates for the low frequency color are determined (YES at S10), the processing at and after step S12 is executed in order to narrow the candidates for the low frequency colors down to two.

In other words, the display control unit 36 determines a display order of the three or more candidates for the low frequency color determined by the low frequency color determination unit 35 (S12). Namely, the display control unit 36 determines the display order of the candidates for the low frequency color such that the candidate for the low frequency color to which a larger number of colors being low in occurrence frequency is continuously adjacent is displayed at a higher rank. For example, the display control unit 36 determines to rank the display order of the candidates for the low frequency color determined by a single-color signal histogram (R signal histogram, G signal histogram or B signal histogram) higher than the display order of the candidates for the low frequency color determined by multi-color signal histogram (R-G signal histogram, R-B signal histogram, G-B signal histogram or R-G-B signal histogram). This is because the candidates for the low frequency color determined by the single color signal histogram makes more colors being low in occurrence frequency continuously adjacent to the candidates for the low frequency colors in the RGB space due to the fact that the values for the color signals of the two colors other than this single color may take any values.

From a similar reason, the display control unit 36 determines to rank the display order of the candidates for the low frequency color determined by a two-color signal histogram (R-G signal histogram, R-B signal histogram or G-B signal histogram) higher than the display order of the candidate for the low frequency color determined by a three-color signal histogram (R-G-B signal histogram).

In the case where there are multiple candidates for the low frequency color determined by the single-color signal histogram, the display control unit 36 determines the display order such that the more the low frequency color are determined by the continuous classes and the larger the number of the continuous classes is, the higher in rank the low frequency color is displayed as illustrated in FIG. 11. The similar comment applies to the display order of the candidates for the low frequency color determined by the multi-color signal histogram.

The display control unit 36 displays the candidates for the low frequency color from the color ranked higher in the determined display order (S14).

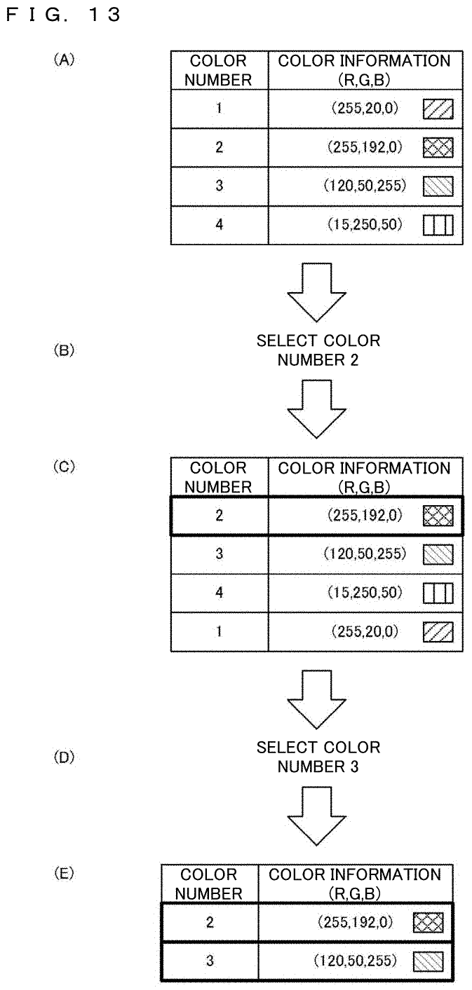

FIG. 13 illustrates low frequency color determination processing. FIG. 13 (A) illustrates a display example on the screen at step S14. On the display screen, sets of color numbers and color information of the low frequency color candidates are displayed. The color information is indicated by a set of luminance values (R, G, B), and an actual color thereof is displayed in an icon next to the luminance values. In FIG. 13(A), four candidates for the low frequency color are displayed.

A selection color acquisition unit 37a is held on standby until the user operates the input device to select a candidate from the candidates for the low frequency color, that is, a first selection color (candidate selected by the user) (S16). Here, the color with No. 2 is assumed to be selected as a first selection color (FIG. 13(B)).

When the selection color acquisition unit 37a acquires the first selection color (YES at step S16), the display control unit 36 determines again the display order of the multiple candidates for the low frequency color depending on the distance from the first selection color to the rest of the candidates for the low frequency color (S18). That is, the display order of the candidates for the low frequency color is determined such that the candidate for the low frequency color that has a longer distance from the first selection color is displayed higher in rank. The distance between colors may here be Euclidean distance between the respective luminance values (R, G, B), or may be an angle (or the inverse of the cosine of the angle) formed by the hues calculated from the luminance values (R, G, B). It is noted that the distance between colors may employ any distance as long as they are yardsticks that may be used to judge the similarity between colors.

The display control unit 36 displays the candidates for the low frequency color on the display screen according to the display order determined again (S20). As illustrated in FIG. 13(C), for example, the color information with No. 2 corresponding to the first selection color is displayed highest in rank. Next, the color information is displayed in the order from the color ranked higher in display order determined again at step S18.

The selection color acquisition unit 37a is held on standby until the user selects a candidate from the candidates for the low frequency color other than the first selection color, that is, acquires a second selection color (candidate selected by the user) (S22). Here, the color with No. 3 is assumed to be selected as a second selection color (FIG. 13(C)).

When the selection color acquisition unit 37a acquires the second selection color (YES at S22), the display control unit 36 displays the first selection color and the second selection color on the display screen (S24). As illustrated in FIG. 13(E), for example, the display control unit 36 displays the color information with No. 2 and No. 3 on the display screen.

Moreover, the low frequency color determination unit 35 transmits the color information of the first selection color and the second selection color to the detection device 4 via the communication unit 31 (S26).

Note that if two or less candidate for the low frequency color is determined in the low frequency color candidate determination processing (NO at S10), the display control unit 36 displays the color information of the low frequency color on the display screen regarding the determined candidate for the low frequency color as a low frequency color (S24). The low frequency color determination unit 35 transmits the color information of the low frequency color to the detection device 4 via the communication unit 31 (S26). Note that if no candidate for the low frequency color is found, the processing at steps S24 and S26 may be skipped.

According to the processing described above, a maximum of two low frequency colors are determined. In the case where the color label 5 is composed of three or more colors, if three or more low frequency colors are required to be determined, processing similar to steps S18 to S22 is further executed after acquisition of the second selection color to thereby determine low frequency colors at and after the third selection color.

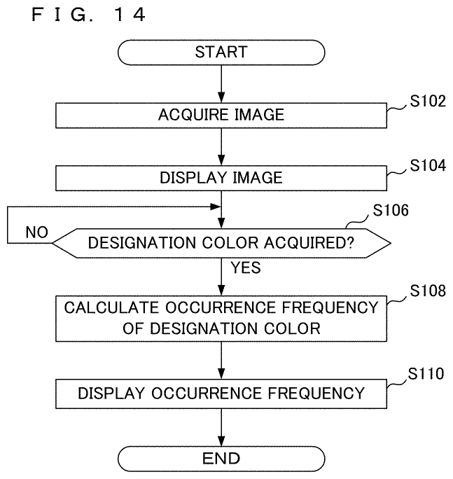

FIG. 14 is a flowchart of another example of a processing procedure performed by the analysis device 3 according to Embodiment 1 of the present disclosure. The processing illustrated in FIG. 14 is used for calibration, etc. after the color label 5 develops the low frequency color determined by the above-described processing, for example. Namely, the processing is used for calibration, etc. to confirm whether or not the occurrence frequency of the color of the color label 5 is sure to be low based on the image of the color label 5 photographed by the camera 2 and to adjust the color of the color label 5.

With reference to FIG. 14, the image acquisition unit 32 acquires an image from the camera 2 via the communication unit 31 (S102). The image acquisition unit 32, for example, acquires an image obtained by photographing the first color label 5A developing the first selection color and the second color label 5B developing the second selection color.

The display control unit 36 displays the image acquired by the image acquisition unit 32 on the display screen (S104).

A designation color acquisition unit 37b is held on standby until it acquires a designation color designated by the user operating the input device (S106). If the user operates the input device to designate a position of the first color label 5A on the image, the designation color acquisition unit 37b acquires a color corresponding to the position as a designation color, for example.

When the designation color acquisition unit 37b acquires the designation color (YES at S106), the occurrence frequency calculation unit 34 calculates the occurrence frequency of the designation color (S108). That is, the occurrence frequency calculation unit 34 calculates the occurrence frequency by acquiring the occurrence frequency of the designation color from the R-G-B signal histogram that had been created according to the R-G-B signal histogram creation processing (S32 in FIG. 9) by the occurrence frequency calculation unit 34 and is stored in the storage unit 33.

The display control unit 36 displays the calculated occurrence frequency of the designation color on the display screen (S110). It is noted that the display control unit 36 may divide the occurrence frequencies into high, medium and low frequencies, and display the levels of the occurrence frequency.

According to such processing, the user can confirm the occurrence frequency of the color represented by the color label 5 in the image, for example. This allows the user to adjust, for example, the color of the color label 5 if the occurrence frequency is high.

[Processing Procedure by Detection Device 4]

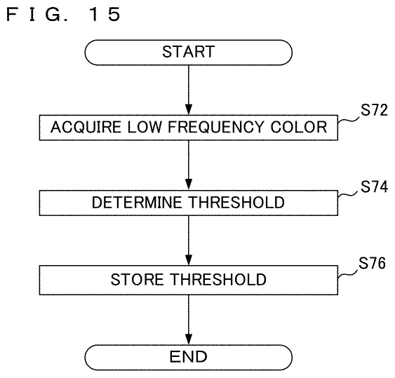

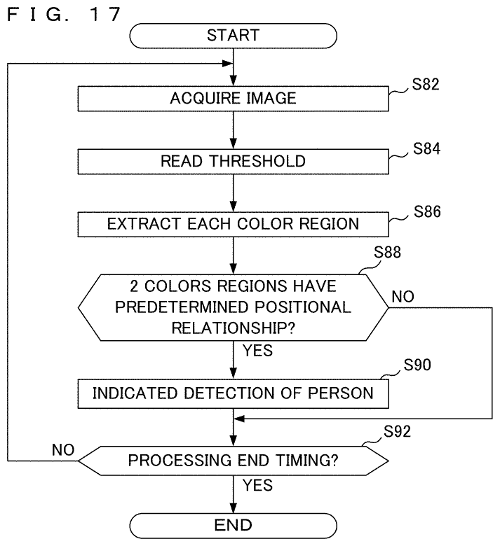

FIG. 15 is a flowchart of one example of a processing procedure performed by the detection device 4 according to Embodiment 1 of the present disclosure. Note that the processing illustrated in FIG. 15 is preprocessing executed prior to processing of detecting the person 61 illustrated in FIG. 17.

The low frequency color acquisition unit 42 acquires from the analysis device 3 the color information of the low frequency color determined by the analysis device 3 via the communication unit 41 (S72). For example, the low frequency color acquisition unit 42 acquires the color information of the first selection color (color with No. 2) and the second selection color (color with No. 3) as illustrated in FIG. 13(E), for example.

The threshold determination unit 43 determines a threshold based on the acquired color information (S74). For example, the threshold determination unit 43 adds 10 to each of the values for the R signal, the G signal and the B signal for each color information to thereby determine an upper threshold limit and subtracts 10 from each of the values to thereby determine a lower threshold limit. Note that the upper threshold limit is restricted to the upper limit value 255 of the luminance value whereas the lower threshold limit is restricted to the lower limit value 0 of the luminance value. For example, the threshold determination unit 43 determines that the upper threshold limit is (255, 202, 10) and determines that the lower threshold limit is (245, 182, 0), from the color information of the first selection color (255, 192, 0). Furthermore, the threshold determination unit 43 determines that the upper threshold limit is (130, 60, 255) and determines that the lower threshold limit is (110, 40, 245), from the color information of the second selection color (120, 50, 255).

The threshold determination unit 43 stores the determined threshold, that is, a set of the upper threshold limit and the lower threshold limit in the threshold storage unit 44 (S76).

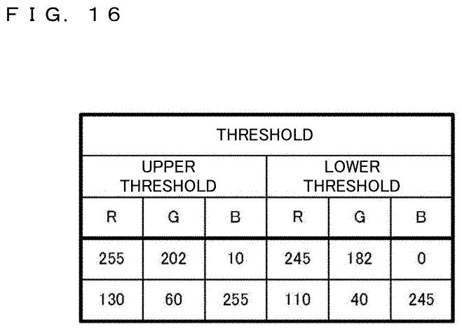

FIG. 16 illustrates an example of the threshold stored in the threshold determination unit 43. In the threshold storage unit 44, the threshold for the first selection color and the threshold for the second selection color, for example, are stored.

FIG. 17 is a flowchart of another example of the processing procedure performed by the detection device 4 according to an embodiment of the present disclosure. The processing illustrated in FIG. 17 is processing for detecting the person 61 corresponding to the object.

The image acquisition unit 45 acquires from the camera 2 an image of the detection target area photographed by the camera 2 via the communication unit 41 (S82).

The detection unit 46 reads the threshold from the threshold storage unit 44 (S84). That is, the detection unit 46 reads out a set of upper threshold limit and lower threshold limit for each of the first selection color and the second selection color as illustrated in FIG. 16.

The detection unit 46 extracts a first selection color region and a second selection color region from the image (S86). That is, the detection unit 46 compares the luminance value of each of the pixels in the image with the upper threshold limit and the lower threshold limit to thereby extract the region. More specifically, the detection unit 46 extracts the pixel of the first selection color from the image. In other words, the detection unit 46 extracts the pixel the luminance value of which is equal to or more than the lower threshold limit of the first selection color and is equal to or less than the upper threshold limit of the first selection color, as a pixel of the first selection color. The detection unit 46 extracts a group of adjacent pixels having the first selection color as a first selection color region. The detection unit 46 also extracts the second selection color region by a similar processing. This allows the detection unit 46 to extract the region including the first color label 5A and the second color label 5B pasted on the helmet 80.

The detection unit 46 determines whether or not the first selection color region and the second selection color region have a predetermined positional relationship (S88). For example, the detection unit 46 determines that the predetermined positional relationship is established if the distance between the barycenter of the first selection color region and the barycenter of the second selection color region is within a predetermined distance. Since a positional relationship between the first color label 5A and the second color label 5B pasted on the helmet 80 is previously known, the predetermined distance used for determination can also be calculated in advance.

If the detection unit 46 determines that the predetermined positional relationship is established (YES at S88), the notification unit 47 transmits, for example, a sound signal indicating detection of the presence of the person 61 to the sound output device, or transmits the message information thereof to the display device or the terminal device (S90). This makes it possible to notify the driver of the forklift 60 that the person 61 is present.

After the notification processing (S90), if the processing end timing is reached (YES at S92), the detection device 4 ends the processing. The processing end timing is a case where the detection device 4 receives a signal indicating that the engine of the forklift 60 is stopped, for example.

If the processing end timing is not reached (NO at S92), the processing is returned to step S82 to repeatedly execute the processing from steps S82 to S90 until the processing end timing is reached.

### Effect of Embodiment 1

According to Embodiment 1 as described above, a low frequency color being a color relatively low in occurrence frequency can be determined from the image obtained by photographing the detection target area including the object. Thus, it is possible to determine the color to be applied to the object in order to accurately detect the object by the image processing. In other words, by applying such a low frequency color to the object, the region with the low frequency color can accurately be detected from the image obtained by photographing the detection target area without being affected by the color of other regions. This makes it possible to accurately detect the object. For example, a low frequency color is determined from an image obtained by photographing the interior of a factory, and the color label 5 developing the low frequency color is pasted on the helmet 80 worn by the person 61. The color of the color label 5 is assured to be low in occurrence frequency in the image. Thus, the color label 5 pasted on the helmet 80 can accurately be detected by the image processing, which enables accurate detection of the person 61.

Furthermore, the low frequency color determination unit 35 can determine the low frequency color in view of the occurrence frequency of each color included in multiple colors positioned close to each other in a predetermined color space. For example, in the case where a color around the color being low in occurrence frequency in the color space is also low in occurrence frequency, the color being low in occurrence frequency can preferentially be determined as a low frequency color. Thus, even if the color of the object corresponding to the low frequency color slightly changes in the image due to the changes of environmental conditions such as solar radiation, weather, lighting or the like, the occurrence frequency of the changed color can also be made low. This enables accurate detection of the object from the image by the image processing independent of the changes of the environmental conditions.

Moreover, in the case where multiple low frequency colors are determined by the low frequency color determination unit 35, depending on the distance from the selection color selected by the user out of the multiple low frequency colors, the rest of the low frequency colors are displayed on the screen. As illustrated in FIG. 13(C), for example, the rest of the low frequency colors are displayed in such an order that the color with a longer distance from the selection color is ranked higher, which allows the user to readily select the low frequency color with high discernibleness.

Additionally, the information on the occurrence frequency corresponding to the designation color acquired by the designation color acquisition unit 37b is displayed on the screen. This allows the user to learn the occurrence frequency or the levels of the occurrence frequency, etc. of the designation color in the image. For example, the user designates the color label 5 developing the low frequency color in the image. This allows the user to learn whether or not the color of the color label 5 is actually low in occurrence frequency, or to confirm whether or not the color label 5 develops an appropriate color.

In the case where the number of colors the color label 5 can develop is limited, the user can learn the occurrence frequency when each of the colors is set as a designation color. This allows the user to determine the color of the color label 5. For example, the user can determine that the designation color being the lowest in occurrence frequency as the color of the color label 5.

Furthermore, the color label 5 develops a color being low in occurrence frequency in the image. In other words, the pixel with a color the same as or similar to that of the color label 5 is less likely to be present in the image. This enables accurate detection of the color label 5 in distinction from other regions by the image processing. This makes it possible to provide the color label 5 that is accurately detected by the image processing.

In addition, the detection device 4 can detect that a low frequency color is included in an image. The low frequency color is a color rarely included in the background, etc. in the image. Hence, by applying the low frequency color to the object, the object can accurately be detected without being affected by the color of the background, etc.

### Modification of Embodiment 1

The analysis device 3 according to Embodiment 1 displays candidates for multiple low frequency colors on the display screen and causes the user to select the low frequency color from them.

In the modification, described is an example in which a low frequency color is determined without causing the user to select a candidate.

That is, referring to FIG. 3, the low frequency color determination unit 35 determines candidates for the low frequency color similarly to Embodiment 1.

The low frequency color determination unit 35 determines a set of low frequency colors by preferentially selecting a set of candidates for colors having a long distance therebetween. For example, in the case where two low frequency colors are determined, the low frequency color determination unit 35 determines the low frequency color by selecting a pair of candidates for colors having the longest distance therebetween. In the case where three or more low frequency colors are determined, the low frequency color determination unit 35 determines a desired number of low frequency colors by repeatedly selecting a candidate for the low frequency color having the next longest distance from any one of the determined low frequency colors.

The discernibleness of the color increases as the distance between the colors increases. According to the present modification, the multiple low frequency colors are determined in such a manner that the distance between the colors is large. If a pair of low frequency colors with a short distance therebetween is selected, the low frequency colors are identified as the same color by the image processing depending on the environmental condition such as solar radiation, weather, lighting or the like, and cannot be discerned. However, by selecting a pair of low frequency colors with a long distance, the low frequency colors can be discerned irrespective of the environmental condition.

### Embodiment 2

In Embodiment 1, the low frequency color and the threshold are determined independent of the time period at which an image is photographed. However, in the case where an object is detected outdoors, etc., the low frequency color may be changed depending on the time period due to the influence of solar radiation, etc., and in some cases, change of the threshold is desirable. In Embodiment 2, described is an example in which a low frequency color and a threshold are determined for each time period at which an image is photographed. In the following description, the difference from Embodiment 1 is mainly described, and the common parts are not repeatedly described.

The configuration of an image processing system according to Embodiment 2 is similar to that illustrated in FIG. 1.

[Configuration of Analysis Device 3]

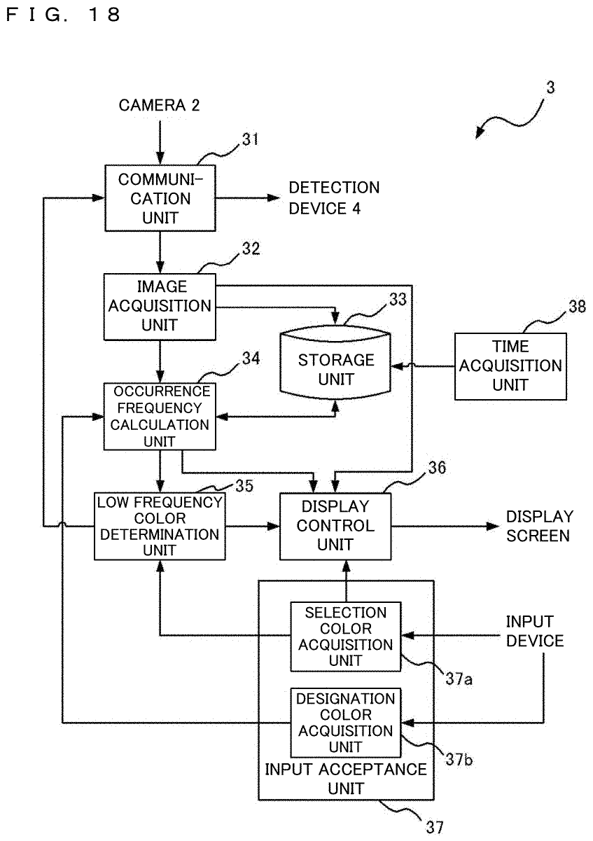

FIG. 18 is a block diagram illustrating the functional configuration of an analysis device 3 according to Embodiment 2 of the present disclosure.

The analysis device 3 is provided by adding a time acquisition unit 38 to the configuration of the analysis device 3 according to Embodiment 1 illustrated in FIG. 3.

The time acquisition unit 38 acquires a time when an image is acquired by the image acquisition unit 32. The time acquisition unit 38 stores in the storage unit 33 the acquisition time acquired and the image acquired and stored in the storage unit 33 by the image acquisition unit 32 in association with each other. The time acquisition unit 38 is configured to include a timer, for example. Note that the time acquisition unit 38 may be configured to acquire a time from an external timer, or the like. In the case where the image acquired by the image acquisition unit 32 includes information on a photographing time, the time acquisition unit 38 may acquire the time from the image.

The occurrence frequency calculation unit 34 calculates an occurrence frequency for each color depending on the time period including the acquisition time of an image acquired by the image acquisition unit 32. In other words, the occurrence frequency calculation unit 34 reads out from the storage unit 33 for each time period such as the daytime, the nighttime, etc. the image photographed in the time period and calculates the occurrence frequency for each color based on the read image. The occurrence frequency calculation method is similar to that in Embodiment 1.

The low frequency color determination unit 35 determines a low frequency color for each time period based on the occurrence frequencies. The low frequency color determination unit 35 transmits a set of color information on determined low frequency color and time period to the detection device 4 via the communication unit 31. The low frequency color determination method is similar to that in Embodiment 1.

The color label 5 is attached to the helmet 80 to be worn by the person 61 and develops the low frequency color determined by the analysis device 3. Since the low frequency color is determined for each time period, the color of the color label 5 is also changed depending on the time period.

[Configuration of Detection Device 4]

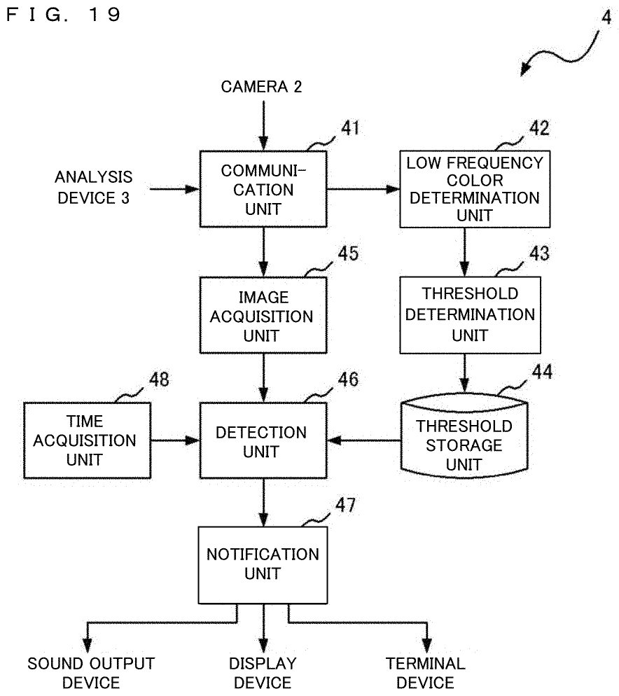

FIG. 19 is a block diagram illustrating the functional configuration of a detection device 4 according to Embodiment 2 of the present disclosure.

The detection device 4 is provided by adding a time acquisition unit 48 to the configuration of the detection device 4 according to Embodiment 1 illustrated in FIG. 4.

The time acquisition unit 48 acquires a time when an image is acquired by an image acquisition unit 45. The time acquisition unit 48 is configured to include a timer, for example. Note that the time acquisition unit 48 may be configured to acquire a time from an external timer or the like. In the case where the image acquired by the image acquisition unit 45 includes information on a photographing time, the time acquisition unit 48 may acquire the time from the image.

The low frequency color acquisition unit 42 acquires from the analysis device 3 the set of color information on the low frequency color determined by the analysis device 3 and time period via the communication unit 41.

The threshold determination unit 43 determines a threshold for detecting the color label 5 developing the low frequency color determined by the analysis device 3 for each time period based on the set of color information on the low frequency color acquired by the low frequency color acquisition unit 42 and time period. The threshold determination method is similar to that in Embodiment 1.

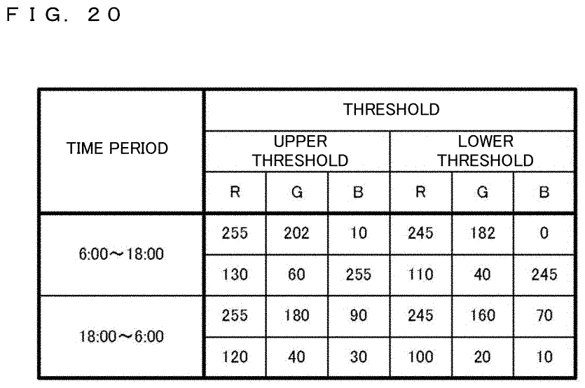

FIG. 20 illustrates an example of a threshold stored in a threshold storage unit 44. In the threshold storage unit 44, a threshold is stored for each time period. For example, two thresholds are stored in association with a time period (6:00-18:00). For one of the thresholds, the upper threshold limit is (255, 202, 10), and the lower threshold limit is (245, 182, 0). For the other of the thresholds, the upper threshold limit is (130, 60, 255), and the lower threshold limit is (110, 40, 245). Similarly, two thresholds are stored in association with a time period (18:00-6:00) though the values of the two thresholds are different from the values of the two thresholds in the time period (6:00-18:00).

Referring again to FIG. 19, the detection unit 46 acquires from the time acquisition unit 48 the time when an image is acquired by the image acquisition unit 45 and reads out a threshold corresponding to the time period including the acquisition time from the threshold storage unit 44. The detection unit 46 detects an object by detecting that the low frequency color is included in the image with the use of the read threshold and the image acquired by the image acquisition unit 45 similarly to Embodiment 1.

[Processing Procedure by Analysis Device 3]

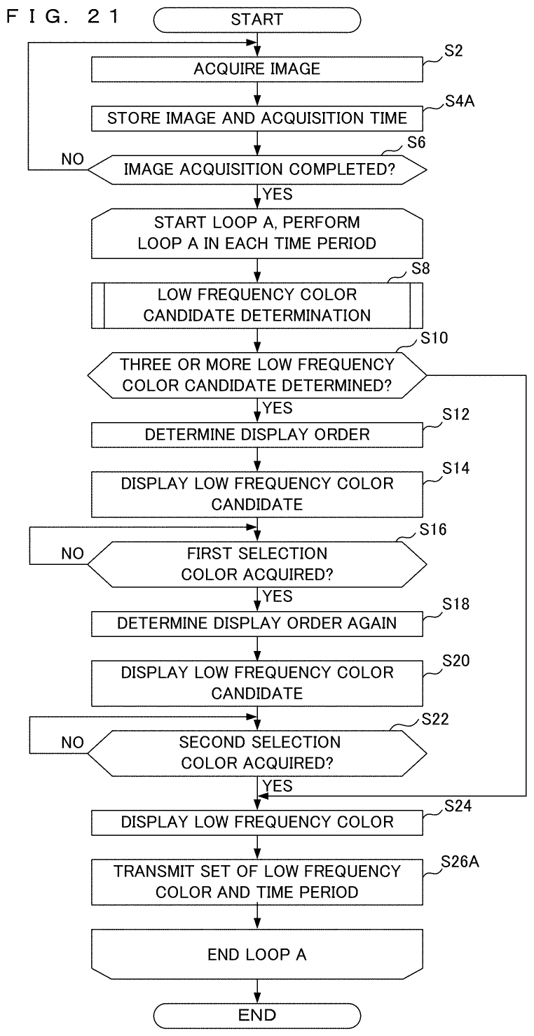

FIG. 21 is a flowchart of one example of a processing procedure performed by the analysis device 3 according to Embodiment 2 of the present disclosure.

The image acquisition unit 32 acquires from the camera 2 an image of the detection target area photographed by the camera 2 via the communication unit 31 (S2).

The image acquisition unit 32 stores the acquired image in the storage unit 33. Furthermore, the time acquisition unit 38 acquires an acquisition time of the image and stores the acquisition time and the image stored in the storage unit 33 in association with each other in the storage unit 33 (S4A).

The image acquisition unit 32 determines whether or not the image acquisition is completed (S6). If the image acquisition is not completed (NO at S6), the processing at steps S2 and S4 is repeatedly executed until the image acquisition is completed.

Subsequently, the analysis device 3 performs processing from steps S8 to S26A (loop A) on images in each time period. In the case the two time periods (6:00-18:00) and (18:00-6:00), for example, the analysis device 3 performs processing from steps S8 to S26A on the images photographed in the time period (6:00-18:00) and then performs the processing from steps S8 to S26A on the images photographed in the time period (18:00-6:00).

The processing at steps S8-S24 is similar to that illustrated in FIG. 8.

At step S26A, the low frequency color determination unit 35 transmits to the detection device 4 a set of color information of each of the first selection color and the second selection color and time period via the communication unit 31.

[Processing Procedure by Detection Device 4]

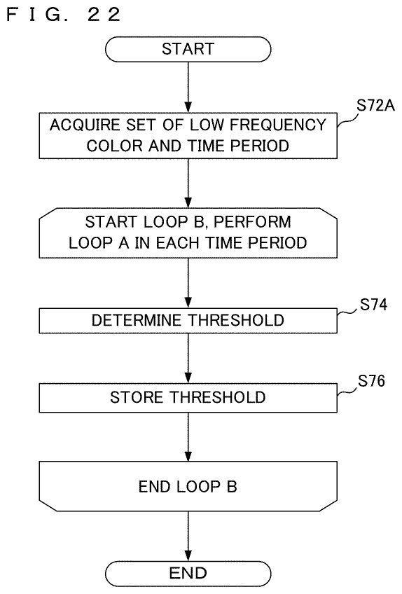

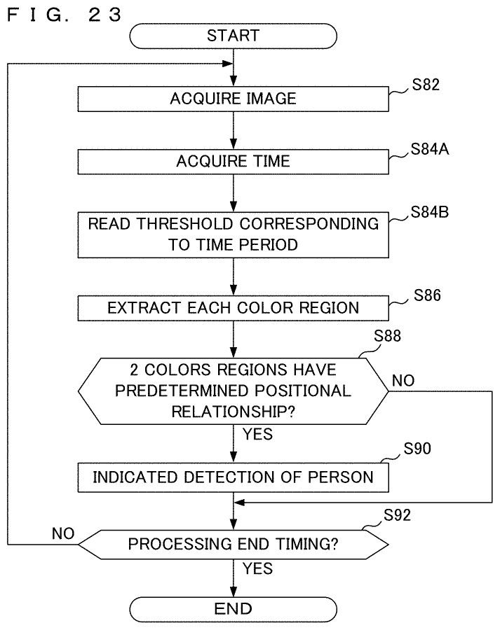

FIG. 22 is a flowchart of one example of a processing procedure performed by the detection device 4 according to Embodiment 2 of the present disclosure. Note that the processing illustrated in FIG. 22 is preprocessing to be executed prior to the processing of detecting the person 61 illustrated in FIG. 23.

The low frequency color acquisition unit 42 acquires from the analysis device 3 the set of color information of the low frequency color determined by the analysis device 3 and time period via the communication unit 41 (S72A).

Subsequently, the detection device 4 performs processing from steps S74 and S76 (loop B) for each acquired time period. The processing at steps S74 and S76 is similar to that illustrated in FIG. 15. In the case of the two time periods (6:00-18:00) and (18:00-6:00), for example, the detection device 4 performs processing at steps S74 and S76 on the images photographed in the time period (6:00-18:00) and then performs the processing at steps S74 and S76 on the images photographed in the time period (18:00-6:00). Thus, the threshold as illustrated in FIG. 20 is stored in the threshold storage unit 44.

FIG. 23 is a flowchart of another example of the processing procedure performed by the detection device 4 according to Embodiment 2 of the present disclosure. The processing illustrated in FIG. 23 is processing for detecting the person 61 corresponding to the object.

The image acquisition unit 45 acquires from the camera 2 an image of the detection target area photographed by the camera 2 via the communication unit 41 (S82).

The time acquisition unit 48 acquires the time when the image is acquired by the camera 2 (S84A).

The detection unit 46 reads out from the threshold storage unit 44 a threshold corresponding to the time period including the acquisition time based on the acquisition time (S84B). Referring to FIG. 20, in the case where the acquisition time is 20:00, the detection unit 46 reads out the two thresholds corresponding to the time period (18:00-6:00) including 20:00. That is, the detection unit 46 reads out the set of upper threshold limit (255, 180, 90) and lower threshold limit (245, 160, 70) as a first threshold and the set of upper threshold limit (120, 40, 30) and lower threshold limit (100, 20, 10) as a second threshold.

Next, the detection device 4 executes processing from steps S86 to S92. The processing from steps S86 to S92 is similar to that illustrated in FIG. 17.

According to Embodiment 2 as described above, the low frequency color can be determined for each time period. This makes it possible to determine a threshold for each time period. Thus, even in the case where an object is detected from an image photographed in the outdoors, etc. where lighting environment changes depending on the time period, for example, the color of the color label 5 to be applied to the object can be changed depending on the time period. Thus, it is possible to detect the object in any time period with high accuracy.

### Embodiment 3

In Embodiment 1, the low frequency color and the threshold are determined independent of the position where an image is photographed. If, however, a background image changes depending on the position such as an image photographed by the camera 2 mounted to the forklift 60, the low frequency color also changes depending on the position. Thus, in some cases, a change in a threshold for detecting an object is desirable in accordance the position. In Embodiment 3, described is an example in which a low frequency color and a threshold are determined for each position where an image is photographed. In the following description, the difference from Embodiment 1 is mainly described, and the common parts are not repeatedly described.

The configuration of an image processing system according to Embodiment 3 is similar to that illustrated in FIG. 1.

[Configuration of Analysis Device 3]

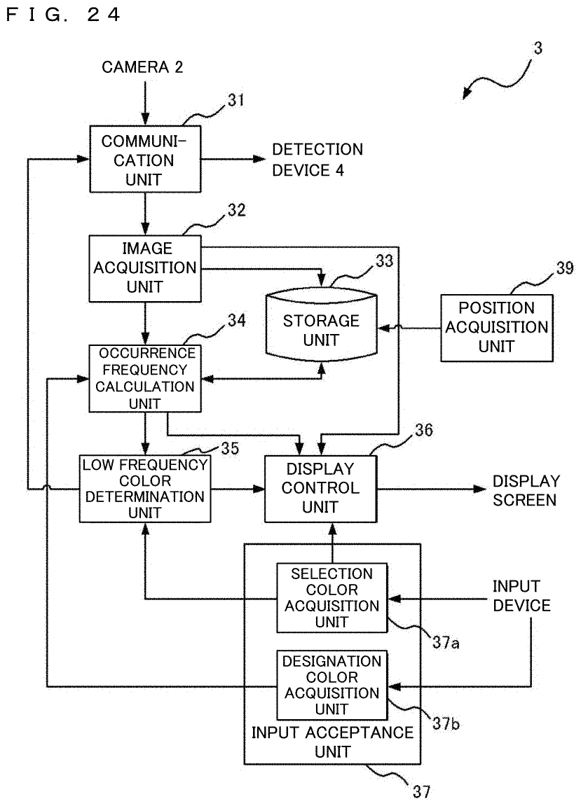

FIG. 24 is a block diagram illustrating the functional configuration of an analysis device 3 according to Embodiment 3 of the present disclosure.

The analysis device 3 is provided by adding a position acquisition unit 39 to the configuration of the analysis device 3 according to Embodiment 1 illustrated in FIG. 3.

The position acquisition unit 39 acquires a position where an image is acquired by the image acquisition unit 32. The position acquisition unit 39 stores in the storage unit 33 the acquisition position acquired and the image acquired and stored in the storage unit 33 by the image acquisition unit 32 in association with each other. The position acquisition unit 39 may acquire a position measured by a GPS receiver, etc. attached to the camera 2 or the forklift 60 as an image acquisition position, or may acquire an attachment position of the camera 2 used for photographing the person 61 as an image acquisition position based on access control information or the like to a room for the person 61 corresponding to the object. Furthermore, the position acquisition unit 39 may measure a position based on the received signal strength indicator (RSSI) of a signal received by the receiver attached the camera 2 or the forklift 60 from an access point for wireless communication such as Wi-Fi (registered trademark), etc. The position acquisition unit 39 can measure the position of the receiver according to the principle of triangulation using multiple RSSIs respectively received from multiple access points by the receiver. In the case where the image acquired by the image acquisition unit 32 includes information on a photographing position, the position acquisition unit 39 may acquire from the image the photographing position as an image acquisition position. In other words, the position acquisition unit 39 can acquire the image acquisition position by using one or more positions out of the position measured by a GPS receiver, etc. the position where the camera 2 is mounted, the position of the receiver based on the reception signal strength of a radio wave and the photographing position included in the image.

The occurrence frequency calculation unit 34 calculates an occurrence frequency for each color depending on the area to which a position where an image is acquired by the image acquisition unit 32 belongs. In other words, the occurrence frequency calculation unit 34 reads out for each area such as a factory A, a factory B or the like an image photographed inside the area from the storage 33, and calculates for each color an occurrence frequency of the color in the image based on the read image. The occurrence frequency calculation method is similar to that in Embodiment 1.

Note that associating an area with a position is assumed to be made in advance. For example, the position is indicated by the latitude and the longitude, and the area is represented by a latitude range and a longitude range.

The low frequency color determination unit 35 determines a low frequency color for each area based on the occurrence frequency. The low frequency color determination unit 35 transmits to the detection device 4 a set of color information of the determined low frequency color and area identifier for identifying an area via the communication unit 31. The low frequency color determination method is similar to that in Embodiment 1.

The color label 5 is attached to, for example, a helmet 80 to be worn by a person 61 and develops the low frequency color determined by the analysis device 3. Since the low frequency color is determined for each area, the color of the color label 5 is also changed depending on the area. The area information may be acquired based on access control information, etc. to a room for the person 61 or may be acquired from the position information measured by the GPS receiver or the like. The GPS receiver may be attached to the helmet 80, or held by the person 61, for example.

[Configuration of Detection Device 4]

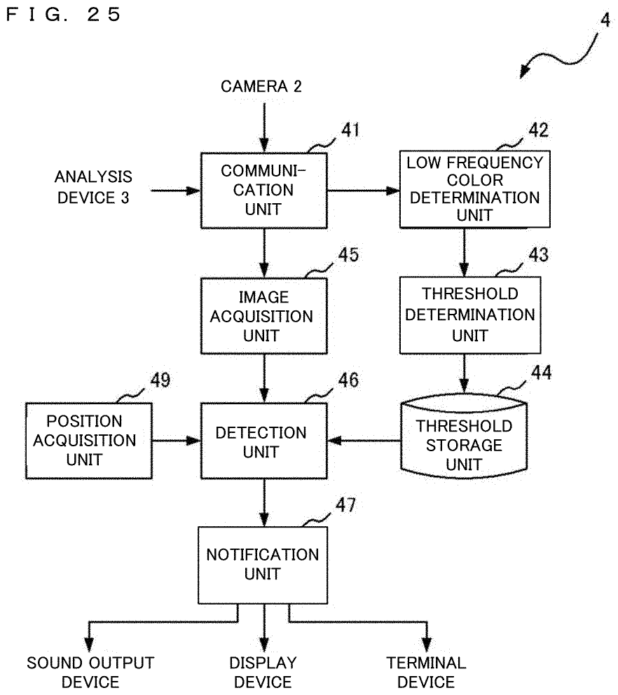

FIG. 25 is a block diagram illustrating the functional configuration of the detection device 4 according to Embodiment 3 of the present disclosure.

The detection device 4 is provided by adding a position acquisition unit 49 to the configuration of the detection device 4 according to Embodiment 1 illustrated in FIG. 4.

The position acquisition unit 49 acquires a position where an image is acquired by an image acquisition unit 45. The position acquisition unit 49 may acquire a position measured by a GPS receiver, etc. attached to the camera 2 or the forklift 60 as an image acquisition position, or may acquire an attachment position of the camera 2 used for photographing the person 61 as an image acquisition position based on access control information, etc. to a room for the person 61 corresponding to the object. Furthermore, the position acquisition unit 49 may measure a position based on the RSSI of a signal received by the receiver attached to the camera 2 or the forklift 60 from an access point for wireless communication such as Wi-Fi (registered trademark), etc. The position acquisition unit 49 can measure the position of the receiver according to the principle of triangulation using multiple RSSIs received from multiple access points by the receiver. In the case where the image acquired by the image acquisition unit 45 includes information on a photographing position, the position acquisition unit 49 may acquire the photographing position from the image as an image acquisition position. In other words, the position acquisition unit 49 can acquire the image acquisition position by using one or more positions out of the position measured by a GPS receiver, etc. the position where the camera 2 is attached, the position of the receiver based on the RSSI of a radio wave and the photographing position included in the image.

The low frequency color acquisition unit 42 acquires from the analysis device 3 the set of color information of the low frequency color determined by the analysis device 3 and area identifier via the communication unit 41.

The threshold determination unit 43 determines a threshold for detecting the color label 5 developing the low frequency color determined by the analysis device 3 for each area based on the set of color information of the low frequency color acquired by the low frequency color acquisition unit 42 and area identifier. The determination method for the threshold is similar to that in Embodiment 1.

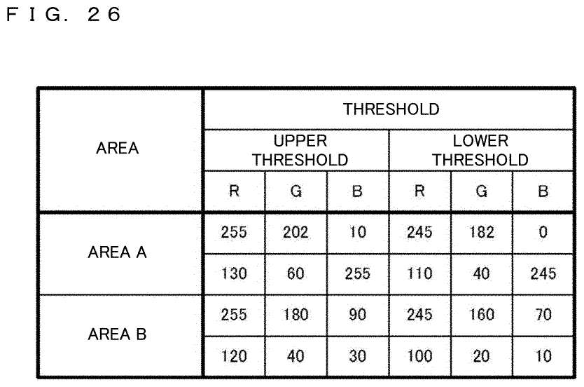

FIG. 26 illustrates an example of a threshold stored in a threshold storage unit 44. In the threshold storage unit 44, a threshold is stored for each area. For example, two thresholds are stored in association with the area A. For one of the thresholds, the upper threshold limit is (255, 202, 10), and the lower threshold limit is (245, 182, 0). For the other of the thresholds, the upper threshold limit is (130, 60, 255), and the lower threshold limit is (110, 40, 245). Similarly, for the area B also, two thresholds are stored though the values of the two thresholds are different from the values of the two thresholds of the area A.

Referring again to FIG. 25, the detection unit 46 acquires from the position acquisition unit 49 a position where an image is acquired by the image acquisition unit 45 and reads out from the threshold storage unit 44 the threshold corresponding to the area to which the acquisition position belongs. The detection unit 46 detects an object by detecting that the low frequency color is included in the image with the use of the read threshold and the image acquired by the image acquisition unit 45, similarly to Embodiment 1.

[Processing Procedure by Analysis Device 3]

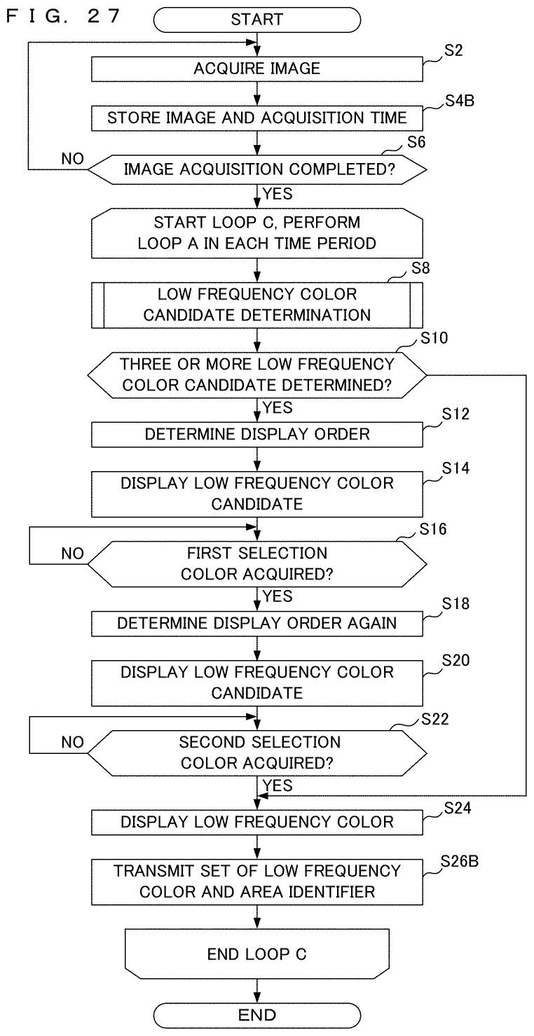

FIG. 27 is a flowchart of one example of a processing procedure performed by the analysis device 3 according to Embodiment 3 of the present disclosure.

The image acquisition unit 32 acquires from the camera 2 an image of the detection target area photographed by the camera 2 via the communication unit 31 (S2).

The image acquisition unit 32 stores the acquired image in the storage unit 33. Furthermore, the position acquisition unit 39 acquires an image acquisition position and stores in the storage unit 33 the acquired position and the image stored in the storage unit 33 in association with each other (S4B).

The image acquisition unit 32 determines whether or not the image acquisition is completed (S6). If the image acquisition is not completed (NO at S6), the processing at steps S2 and S4B is repeatedly executed until the image acquisition is completed.

Subsequently, the analysis device 3 performs processing from steps S8 to S26B (loop C) on the image for each area. In the case of the two areas of the area A and the area B, for example, the analysis device 3 performs processing from steps S8 to S26B on the images photographed in the area A and then performs the processing from steps S8 to S26B on the images photographed in the area B.

The processing from steps S8 to S24 is similar to that illustrated in FIG. 8.

At step S26B, the low frequency color determination unit 35 transmits a set of color information of the first selection color and the second selection color and the area identifier to the detection device 4 via the communication unit 31.

[Processing Procedure by Detection Device 4]

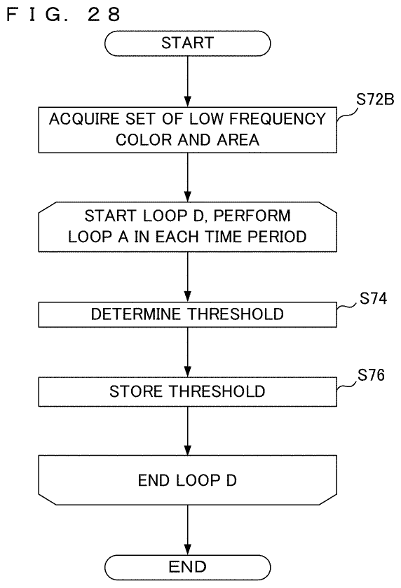

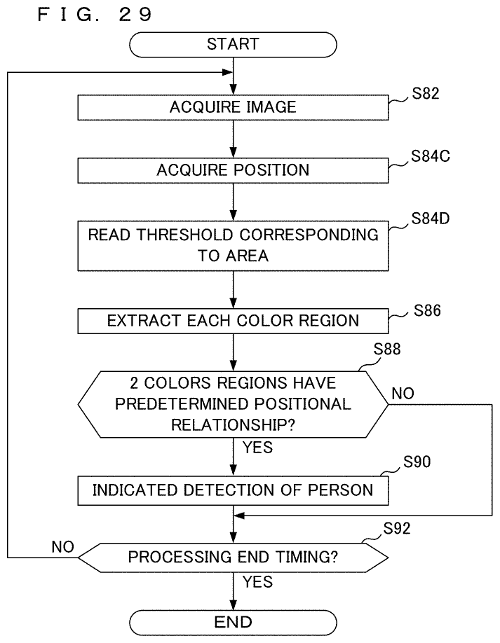

FIG. 28 is a flowchart of one example of a processing procedure performed by the detection device 4 according to Embodiment 3 of the present disclosure. Note that the processing illustrated in FIG. 28 is preprocessing to be executed prior to the processing of detecting the person 61 illustrated in FIG. 29.

The low frequency color acquisition unit 42 acquires from the analysis device 3 the set of color information on the low frequency color determined by the analysis device 3 and area identifier via the communication unit 41 (S72B).

The detection device 4 then performs processing at steps S74 and S76 (loop D) for each area indicated by the acquired area identifier. The processing at steps S74 and S76 is similar to that illustrated in FIG. 15. In the case that two areas of the area A and the area B are present, the detection device 4 performs processing at steps S74 and S76 on the area A and then performs the processing at steps S74 and S76 on the area B. Thus, the threshold as illustrated in FIG. 26 is stored in the threshold storage unit 44.

FIG. 29 is a flowchart of another example of the processing procedure performed by the detection device 4 according to Embodiment 3 of the present disclosure. The processing illustrated in FIG. 29 is processing for detecting the person 61 corresponding to the object.

The image acquisition unit 45 acquires from the camera 2 an image of the detection target area photographed by the camera 2 via the communication unit 41 (S82).

The position acquisition unit 49 acquires the position where the image is acquired by the camera 2 (S84C).

The detection unit 46 reads out a threshold corresponding to the area to which the acquisition position belongs based on the acquisition position from the threshold storage unit 44 (S84D). Referring to FIG. 26, in the case where the acquisition position belongs to the area B, for example, the detection unit 46 reads out the two thresholds corresponding to the area B. That is, the detection unit 46 reads out the set of upper threshold limit (255, 180, 90) and lower threshold limit (245, 160, 70) as a first threshold and the set of upper threshold limit (120, 40, 30) and lower threshold limit (100, 20, 10) as a second threshold.

Subsequently, the detection device 4 executes processing from steps S86 to S92. The processing from S86 to S92 is similar to that illustrated in FIG. 17.

According to Embodiment 3 as described above, the low frequency color can be determined for each area. This makes it possible to determine a threshold for each area. Thus, even in the case where an object is detected from an image photographed by a camera mounted to the vehicle, or even in the case where an object is detected from images photographed by cameras placed in multiple areas, for example, the color of the color label 5 to be applied to the object can be changed depending on the position of the camera. Thus, it is possible to detect an object with high accuracy.

### Embodiment 4

In Embodiment 1, a low frequency color is determined whereas the size of the region of the low frequency color in the image is not considered. In Embodiment 4, an example in which a low frequency color is determined in view of the size of each region of the low frequency color in the image.

The configuration of an image processing system according to Embodiment 4 is similar to that illustrated in FIG. 1.

[Configuration of Analysis Device 3]

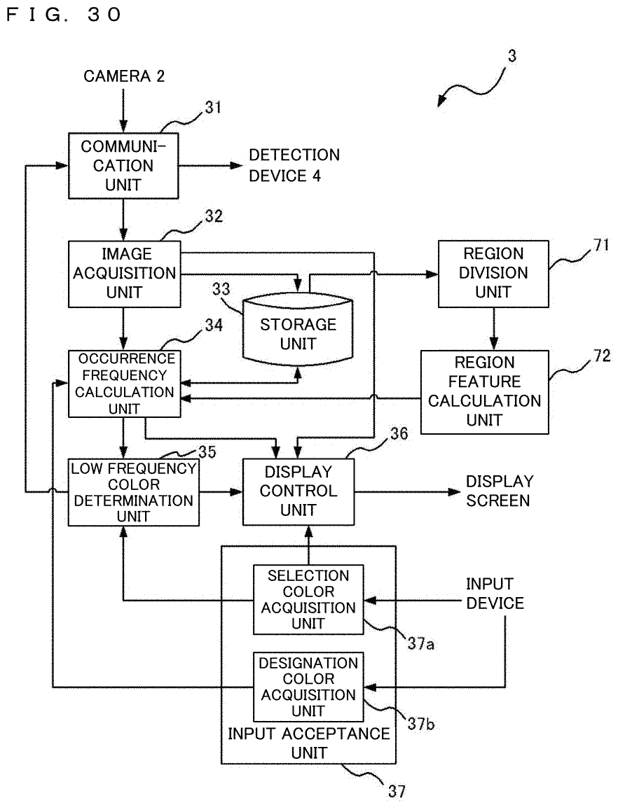

FIG. 30 is a block diagram illustrating the functional configuration of an analysis device 3 according to Embodiment 4 of the present disclosure.

The analysis device 3 is provided by adding a region division unit 71 and a region feature calculation unit 72 to the configuration of the analysis device 3 according to Embodiment 1 illustrated in FIG. 3.

The region division unit 71 performs region division processing on the image acquired by the image acquisition unit 45 based on the color of each of the pixels. That is, the region division unit 71 executes the region division processing for extracting neighboring pixels having a similar color in an image as one region. The region division processing is well-known processing, and thus the details thereof is not repeatedly described here.

The region feature calculation unit 72 calculates for each region divided by the region division unit 71 the size and the representative color of the region. For example, the region feature calculation unit 72 calculates a representative value by calculating the average value or the median value for the luminance values R, the luminance values G and the luminance values B of the respective pixels included in the region. It is noted that the representative color calculation method is not limited to the above-described method. For example, the mode, the maximum value or the minimum value for the luminance values R, the luminance values G and the luminance values B may be calculated as a representative value.

The occurrence frequency calculation unit 34 calculates for each set of size and representative color the occurrence frequency of the region having the set based on the size and the representative color of the region calculated by the region feature calculation unit 72. In the case where the size is assumed as (S), and the representative color is assumed as luminance values of R (red), G (green) and B (blue) in the RGB color space, the occurrence frequency is calculated for each set (S, R, G, B).

The low frequency color determination unit 35 determines a set of size (low frequency size) and representative color (low frequency color) being low in occurrence frequency as compared with other sets based on the occurrence frequency of the region for each set calculated by the occurrence frequency calculation unit 34. The low frequency color determination unit 35 transmits the determined set of low frequency size and low frequency color to the detection device 4 via the communication unit 31.

[Configuration of Color Label 5]

The color label 5 is attached to, for example, a helmet 80 to be worn by a person 61 and develops the low frequency color determined by the analysis device 3. Furthermore, if the color label 5 is photographed by the camera 2, the color label 5 has an actual size such that the size of the color label 5 in the image matches the low frequency size determined by the analysis device 3. Hence, if the color label 5 is formed of two color labels of a first color label 5A and a second color label 5B, these color labels may have different colors and sizes.

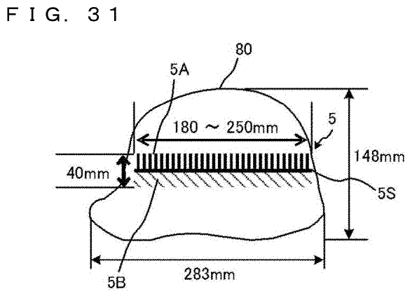

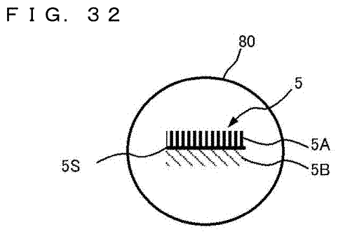

With reference to FIGS. 31 and 32, described is an attachment example of the color label 5.

FIG. 31 illustrates the helmet to be worn by the person 61 when viewed from the side whereas FIG. 32 illustrates the helmet when viewed from above. As illustrated in FIG. 31 and FIG. 32, the color label 5 is pasted on the helmet 80. The color label 5 is formed of the first color label 5A and the second color label 5B arranged in parallel. As illustrated in FIG. 31, assuming that the helmet 80 is 283 mm wide and 148 mm high, the color label 5 can be about 40 mm wide and about 180-250 mm long. It is noted that a clearance region 5S is provided between the first color label 5A and the second color label 5B. The clearance region 5S is, for example, a black region, and 2-3 mm in width. As illustrated in FIG. 32, a similar color label 5 is also pasted on the top of the helmet 80. Color labels 5 are also pasted on the opposite side and the front and back of the helmet 80. Hence, by pasting the color labels 5 on various positions of the helmet 80, any one of the color labels 5 can be photographed by the camera 2 even if the person 61 takes any posture (upright position, squatting posture, or the like).

Note that the color label 5 may be formed of a cloth, a tape, a paint or the like and may develop a specific color. In this case, it is more preferable that the color label 5 is formed of a fluorescent tape or is applied with a fluorescent paint, for example. This makes it easy to perceive the color label 5 even in conditions of a low luminance such as in nighttime or cloudy conditions, for example. This also makes it possible to perceive the label without using a specific camera such as an infrared camera or the like. Furthermore, the color label 5 may be configured to have a light-emitting element 53 as illustrated in FIG. 5.

[Configuration of Detection Device 4]

The functional configuration of the detection device 4 is similar to that illustrated in FIG. 4. It is noted that there are differences in the processing executed by the low frequency color acquisition unit 42, the threshold determination unit 43 and the detection unit 46 as well as in the threshold stored in the threshold storage unit 44.

That is, the low frequency color acquisition unit 42 acquires a set of low frequency size and low frequency color from the analysis device 3 via the communication unit 41.

The threshold determination unit 43 determines a threshold for detecting the color label 5 that develops the low frequency color determined by the analysis device 3 and has the size similar to the low frequency size based on the set of low frequency size and low frequency color acquired by the low frequency color acquisition unit 42. For example, in the case where the set of low frequency size and low frequency color is represented by (S1, R1, G1 and B1), the threshold determination unit 43 determines that the lower threshold limit is (S1−100, R1−10, G1−10, B1−10), and the upper threshold limit is (S1+100, R1+10, G1+10, B1+10). The threshold determination unit 43 writes the determined threshold into the threshold storage unit 44. In the case where the low frequency color acquisition unit 42 acquires multiple sets of low frequency size and low frequency color, the threshold determination unit 43 determines the threshold for each set and writes it into the threshold storage unit 44.

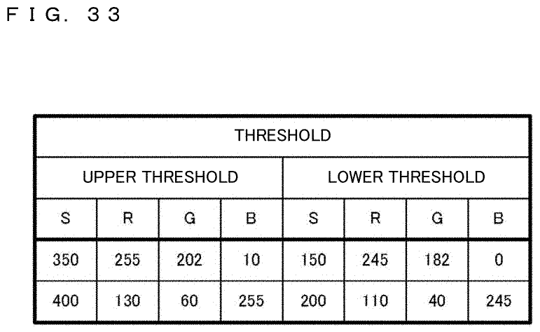

FIG. 33 illustrates an example of a threshold stored in the threshold storage unit 44. For example, two thresholds are stored in the threshold storage unit 44. For one of the thresholds, the upper threshold limit is (350, 255, 202, 10), and the lower threshold limit is (150, 245, 182, 0). For the other of the thresholds, the upper threshold limit is (400, 130, 60, 255), and the lower threshold limit is (200, 110, 40, 245).

The detection unit 46 detects that the region with the low frequency size and the low frequency color acquired by the low frequency color acquisition unit 42 is included, that is the color label 5 is included, in the image acquired by the image acquisition unit 45. In other words, the detection unit 46 divides the image acquired by the image acquisition unit 45 into regions similarly to the region division unit 71. Furthermore, the detection unit 46 reads out the threshold from the threshold storage unit 44. The detection unit 46 determines whether or not the region with the low frequency size and the low frequency color is included in the image based on the divided region and the threshold. For example, if the size and the representative color of the divided region fall within the range between the upper threshold limit and the lower threshold limit that are read out, the detection unit 46 detects that the region with the low frequency size and the low frequency color is included in the image. This allows the detection unit 46 to detect the color label 5.

[Processing Procedure by Analysis Device 3]

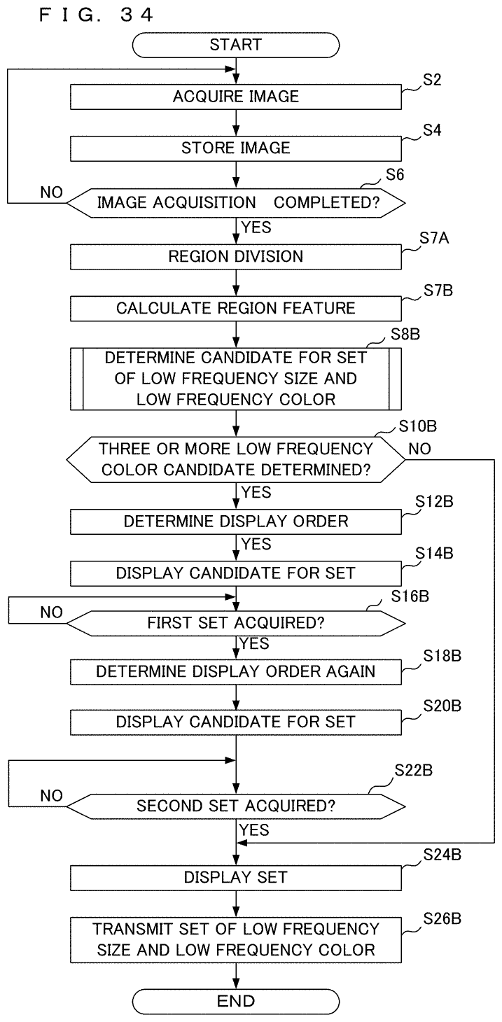

FIG. 34 is a flowchart of one example of a processing procedure performed by the analysis device 3 according to Embodiment 4 of the present disclosure.

The analysis device 3 executes processing from steps S2 to S6. The processing from steps S2 to S6 is similar to that illustrated in FIG. 8.

If it is judged that the image acquisition is completed (YES at step S6), the region division unit 71 reads out the image from the storage unit 33 and performs the region division processing on the read image (S7A).

The region feature calculation unit 72 calculates the size and the representative color for each region obtained through division by the region division unit 71 (S7B).

The occurrence frequency calculation unit 34 and the low frequency color determination unit 35 determine a candidate for set of low frequency size and low frequency color based on the sizes and the representative colors of the respective regions calculated by the region feature calculation unit 72 (S8B).

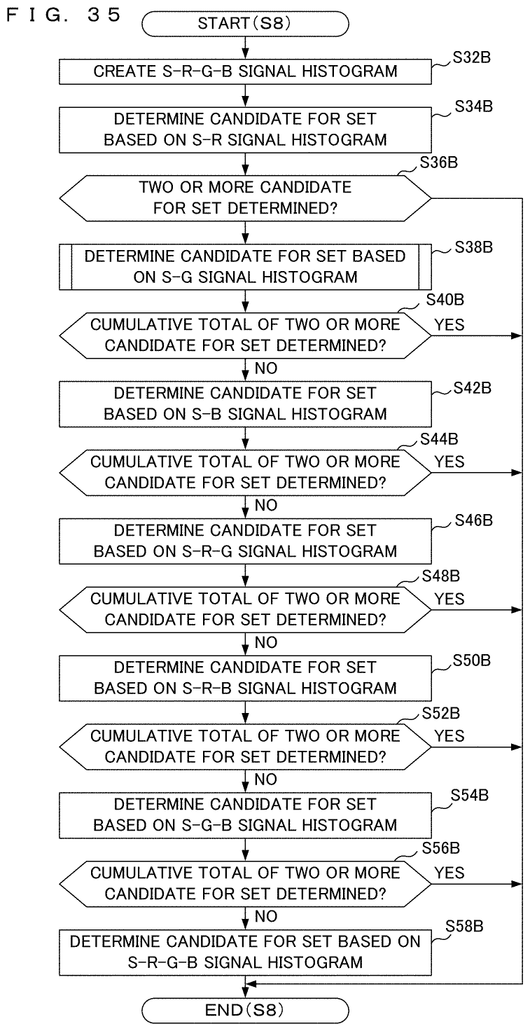

FIG. 35 is a flowchart of detailed processing procedure of the processing of determining candidates for sets of low frequency sizes and low frequency colors (S8B).

The occurrence frequency calculation unit 34 creates an S-R-G-B signal histogram based on the sizes and representative colors of the respective regions calculated by the region feature calculation unit 72 (S32B). The occurrence frequency calculation unit 34 stores the created S-R-G-B signal histogram in the storage unit 33.

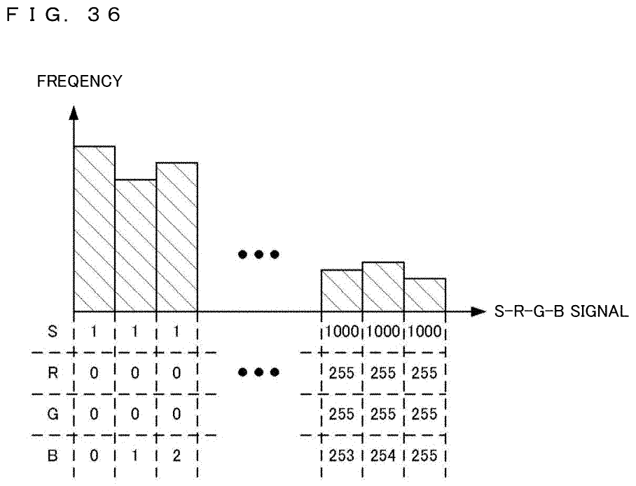

FIG. 36 illustrates one example of the S-R-G-B signal histogram, where the horizontal axis indicates sets of sizes (S) and representative colors (R, G, B) whereas the vertical axis indicates the frequency of each set. The luminance value R (R signal), the luminance value G (G signal) and the luminance value (B signal) are each an integer value in the range of 0 to 255. Furthermore, the size (S signal) is an integer value in the range of 1 to 1000 as one example. In other words, the occurrence frequency calculation unit 34 creates the S-R-G-B signal histogram by tabulating the sets of sizes and representative colors of the respective regions calculated by the region feature calculation unit 72.

Subsequently, the occurrence frequency calculation unit 34 creates an S-R signal histogram from the S-R-G-B signal histogram whereas the low frequency color determination unit 35 determines a candidate for a set of low frequency size and low frequency color based on the S-R signal histogram (S34A).

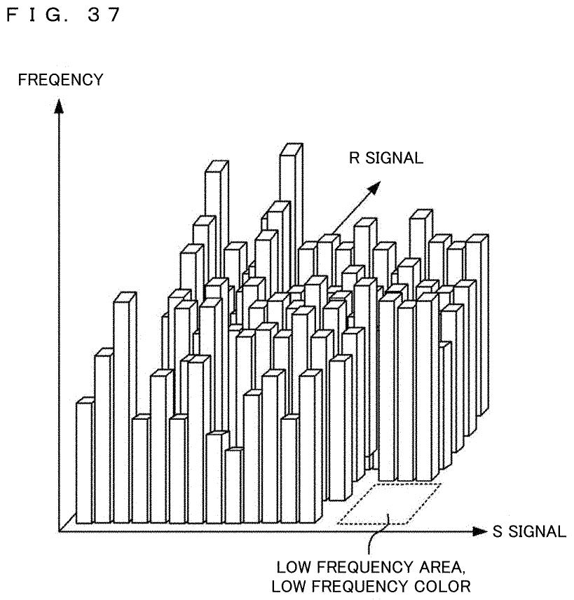

Describing in detail, FIG. 37 illustrates one example of the S-R signal histogram, where the first axis indicates S signals (size), the second axis perpendicular to the first axis indicates R signals, and the third axis perpendicular to the first axis and the second axis indicates the frequencies of sets of S signals and R signals. It is assumed that the S signals are quantized for every 10 steps whereas the R signals are assumed to be quantized for every 8 steps. For example, one frequency is set to the class (S, G)=(1-10, 0-7). The number of steps for quantization may, however, take any number, not limited to the above.

The low frequency color determination unit 35 determines a set of low frequency size and low frequency color for each class the frequency of which is equal to or less than the threshold. For example, the median value of the S signals in the class is determined as a value for the low frequency size whereas the median value of the R signals in the class is determined as a value for the R signal of the low frequency color. Here, the low frequency color is determined from the S-R signal histogram without taking the G signal and the B signal into consideration. Hence, the values for the G signal and the B signal of the low frequency color may take any values. For example, the values for the G signal and the B signal may be determined at random or may be determined as median values or preset values of the values the respective signals may take.

The low frequency color determination unit 35 judges whether or not candidates for two or more sets of low frequency sizes and low frequency colors are determined (S36B). If the candidates for two or more sets of low frequency sizes and low frequency colors are determined (YES at step S36B), the low frequency color candidate determination processing (58B) is ended.

If the candidates for two or more sets are not determined (NO at step S36B), the occurrence frequency calculation unit 34 creates in order an S-G signal histogram, an S-B signal histogram, an S-R-G signal histogram, an S-R-B signal histogram, an S-G-B signal histogram, and an S-R-G-B signal histogram, whereas the low frequency color determination unit 35 determines a candidate for a set of low frequency size and low frequency color based on each of the histograms (S38B-S58B) unless the cumulative total of candidates for two or more sets of low frequency sizes and low frequency colors are determined.

Referring again to FIG. 34, the analysis device 3 executes processing from steps S10B to S26B after the candidate set determination processing (S8B) as described above. The processing is similar to that at steps S10-S26 illustrated in FIG. 8. Note that there is a difference in that two sets are determined from candidates for sets of low frequency size and low frequency color, not that two low frequency colors are determined from the candidates for the low frequency color. The determined sets of low frequency size and low frequency color are transmitted to the detection device 4.

[Processing Procedure by Detection Device 4]

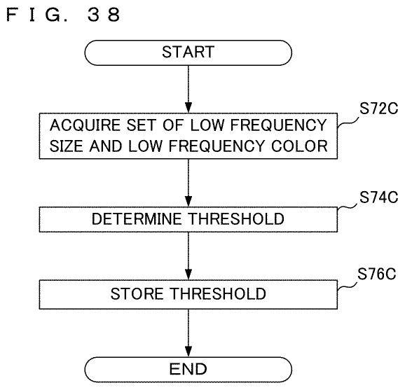

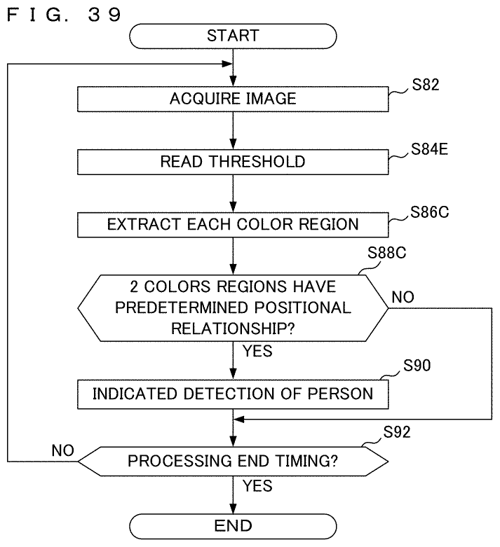

FIG. 38 is a flowchart of one example of a processing procedure performed by the detection device 4 according to Embodiment 4 of the present disclosure. Note that the processing illustrated in FIG. 38 is preprocessing executed prior to the processing of detecting the person 61 illustrated in FIG. 39.

The low frequency color acquisition unit 42 acquires from the analysis device 3 the sets of low frequency sizes and low frequency colors determined by the analysis device 3 via the communication unit 41 (S72C).

The threshold determination unit 43 determines a threshold for detecting the color label 5 that develops the low frequency color determined by the analysis device 3 and has the size similar to the low frequency size based on the sets of low frequency sizes and low frequency colors acquired by the low frequency color acquisition unit 42 (S74C).

The threshold determination unit 43 writes the determined threshold into the threshold storage unit 44 (S76C).

FIG. 39 is a flowchart of another example of the processing procedure performed by the detection device 4 according to Embodiment 4 of the present disclosure. The processing illustrated in FIG. 39 is processing for detecting the person 61 corresponding to the object.

The image acquisition unit 45 acquires from the camera 2 an image of a detection target area photographed by the camera 2 via the communication unit 41 (S82).

The detection unit 46 reads out a threshold from the threshold storage unit 44 (S84E). That is, the threshold as illustrated in FIG. 33 is read out.

The detection unit 46 divides the image acquired by the image acquisition unit 45 into regions. The detection unit 46 extracts from the image the region with the low frequency size and the low frequency color based on the divided regions and the threshold. That is, the detection unit 46 extracts the region having the size and the color equal to or more than the lower threshold limit and equal to or less than the upper threshold limit (S86C).

The detection unit 46 determines whether or not two color regions are extracted, and the two color regions have a predetermined positional relationship (S880. The predetermined positional relationship is similar to that described at step S88 illustrated in FIG. 17.

Thereafter, processing from steps S90 and S92 is executed. The processing is similar to that illustrated in FIG. 17.

According to Embodiment 4 as described above, by the region division processing, an image is divided into regions each composed of pixels having a similar color. Furthermore, based on the occurrence frequencies of sets of sizes and representative colors of the region, sets of low frequency sizes and low frequency colors can be determined. This makes it possible to determine a color to be applied to an object and the size of the color in order to accurately detect the object by the image processing. For example, if the color label 5 is configured to have the low frequency size and develop the low frequency color, the color label 5 can be detected from the image by the image processing. This enables detection of the object.

### ADDITIONAL REMARKS

In the forgoing description, the image processing system 1 according to the embodiments of the present disclosure is described though the disclosure is not limited to the embodiments.

In the above-described embodiments, for example, described is an example where the color label 5 is applied to one person 61 though it may be applied to multiple persons 61. In such a case, the low frequency color being the color of the color label 5 may be changed for each person 61. This allows the detection device 4 to detect one person 61 from another.

Furthermore, each of the analysis device 3 and the detection device 4 as described above may concretely be configured as a computer system formed of a microprocessor, a read only memory (ROM), a RAM, an HDD, a display unit, a keyboard, a mouse and so on. In the RAM or the HDD, a computer program is stored. The microprocessor operates according to the computer program to thereby cause each of the aforementioned devices to achieve the function.

Moreover, a part or all of the components constituting each of the aforementioned devices may be formed of one system LSI. The system LSI is a super multi-functional LSI manufactured by integrating the plural structural units into a single chip and is specifically a computer system configured to include a microprocessor, a ROM, a RAM and so on. In the RAM, a computer program is stored. The microprocessor operates according to the computer program to thereby cause the system LSI to achieve the function.

Additionally, the present disclosure may be methods described above. The present disclosure may also be a computer program executing these methods by the computer, or may be a digital signal including the above-described computer program.

In addition, the present disclosure may be made by recording the above-described computer program or the above-described digital signal in a computer readable non-transitory recording medium, for example, an HDD, a CD-ROM, a semiconductor memory, and so on.

Furthermore, the present disclosure may be configured to transmit the above-described computer program or the above-described digital signal via an electric communication line, wireless or wired communication line, a network typified by the Internet, data broadcasting, etc.

Moreover, a part or all of the functions of each of the aforementioned devices may be provided by cloud computing. That is, a part or all of the functions of the devices may be achieved by a cloud server. For example, in the analysis device 3, the functions of the occurrence frequency calculation unit 34 and the low frequency color determination unit 35 are achieved by the cloud server, and the analysis device 3 may be configured to transmit an image to a cloud server and acquire a low frequency color corresponding to the image from the cloud server.

Additionally, the above-described embodiments and the modification may be combined.

It is to be understood that the embodiments disclosed here is illustrative in all respects and not restrictive. The scope of the present invention is defined by the appended claims, and all changes that fall within the meanings and the bounds of the claims, or equivalence of such meanings and bounds are intended to be embraced by the claims.

### DESCRIPTION OF REFERENCE NUMERALS

1 image processing system
2 camera
3 analysis device
4 detection device
5 color label
5A first color label
5B second color label
5S clearance region
31 communication unit
32 image acquisition unit
33 storage unit
34 occurrence frequency calculation unit
35 low frequency color determination unit
36 display control unit
37 input acceptance unit
37a selection color acquisition unit
37b designation color acquisition unit
38 time acquisition unit
39 position acquisition unit
41 communication unit
42 low frequency color determination unit
43 threshold determination unit
44 threshold storage unit
45 image acquisition unit
46 detection unit
47 notification unit
48 time acquisition unit
49 position acquisition unit
51 interface unit
52 control unit
53 light-emitting element
60 forklift
61 person
71 region division unit
72 region feature calculation unit
80 helmet

What is claimed is:

1-14. (canceled)

15. A computer readable non-transitory recording medium recording an image processing program causing a computer to function as:
an image acquisition unit that acquires an image obtained by photographing a detection target area including an object;
an occurrence frequency calculation unit that calculates for each color an occurrence frequency of the color in the image, based on the image acquired by the image acquisition unit; and
a low frequency color determination unit that determines a low frequency color being a color low in occurrence frequency as compared with other colors based on the occurrence frequency for each color calculated by the occurrence frequency calculation unit.

16. The computer readable non-transitory recording medium recording the image processing program according to claim 15, wherein the low frequency color determination unit determines the low frequency color in view of the occurrence frequency of each color included in a plurality of colors positioned close to each other in a predetermined color space.

17. The computer readable non-transitory recording medium recording the image processing program according to claim 15 causing the computer to further function as:
a region division unit that performs processing of dividing the image acquired by the image acquisition unit into regions based on a color of each pixel; and
a region feature calculation unit that calculates for each region obtained through division by the region division unit a size and a representative color of the region,
wherein
the occurrence frequency calculation unit calculates for each set of size and representative color an occurrence frequency in the image of a region including the set based on the size and the representative color of the region calculated by the region feature calculation unit, and
the low frequency color determination unit determines a set of size and representative color being low in occurrence frequency than other sets based on the occurrence frequency of the region for each set calculated by the occurrence frequency calculation unit.

18. The computer readable non-transitory recording medium recording the image processing program according to claim 15, wherein the low frequency color determination unit determines a plurality of low frequency colors by preferentially selecting a set of low frequency colors with an increased distance between the colors based on the occurrence frequency.

19. The computer readable non-transitory recording medium recording the image processing program according to claim 15 causing the computer to further function as:
a display control unit that displays the plurality of low frequency colors determined by the low frequency color determination unit on a screen; and
a selection color acquisition unit that acquires a selection color being a color selected by a user out of the plurality of low frequency colors displayed on the screen, wherein
the display control unit further displays the plurality of low frequency colors on the screen depending on a distance from the selection color acquired by the selection color acquisition unit.

20. The computer readable non-transitory recording medium recording the image processing program according to claim 15 causing the computer to further function as:
a time acquisition unit that acquires an acquisition time of the image acquired by the image acquisition unit,
wherein
the occurrence frequency calculation unit calculates an occurrence frequency for each color depending on a time period including the acquisition time acquired by the time acquisition unit, and
the low frequency color determination unit determines a low frequency color depending on the time period based on the occurrence frequency calculated by the occurrence frequency calculation unit.

21. The computer readable non-transitory recording medium recording the image processing program according to claim 15 causing the computer to further function as:
a position acquisition unit that acquires an acquisition position of the image acquired by the image acquisition unit, wherein
the occurrence frequency calculation unit calculates an occurrence frequency for each color depending on an area to which the acquisition position acquired by the position acquisition unit belongs, and
the low frequency color determination unit determines a low frequency color depending on the area based on the occurrence frequency calculated by the occurrence frequency calculation unit.

22. The computer readable non-transitory recording medium recording the image processing program according to claim 15 causing the computer to further function as:
a designation color acquisition unit that acquires a designation color; and
an output unit that outputs information on an occurrence frequency of the designation color acquired by the designation color acquisition unit based on the occurrence frequency for each color calculated by the occurrence frequency calculation unit.

23. The computer readable non-transitory recording medium recording the image processing program according to claim 15 causing the computer to further function as
a threshold determination unit that determines a threshold for identifying the low frequency color based on the low frequency color determined by the low frequency color determination unit.

24. A color label emitting light of a low frequency color determined by executing on a computer the image processing program recorded in the computer readable non-transitory recording medium according to claim 15.

25. A detection device comprising:
a threshold acquisition unit that acquires a threshold for identifying a low frequency color determined by executing on a computer the image processing program recorded in the computer readable non-transitory recording medium according to claim 15;
an image acquisition unit that acquires an image of a detection target area including an object; and
a detection unit that detects that the low frequency color is included in the image acquired by the image acquisition unit based on the threshold acquired by the threshold acquisition unit.

26. An image processing apparatus comprising:
an image acquisition unit that acquires an image obtained by photographing a detection target area including an object;
an occurrence frequency calculation unit that calculates for each color an occurrence frequency of the color in the image, based on the image acquired by the image acquisition unit; and
a low frequency color determination unit that determines a low frequency color being a color low in occurrence frequency as compared with other colors based on the occurrence frequency for each color calculated by the occurrence frequency calculation unit.

27. An image processing method comprising:
acquiring an image obtained by photographing a detection target area including an object;
calculating for each color an occurrence frequency of the color in the image based on the acquired image; and
determining a low frequency color being a color low in occurrence frequency as compared with other colors based on the calculated occurrence frequency for each color.

28. An image processing system comprising:
the image processing apparatus according to claim 26;
the color label according to claim 24; and
the detection device according to claim 25.
